(19) United States
(12) Patent Application Publication
(10) Pub. No.: US 2011/0119261 A1
(43) Pub. Date: May 19, 2011

(54) SEARCHING USING SEMANTIC KEYS

(75) Inventor: Hong Liang Qiao, Concord (AU)

(73) Assignee: LEXXE PTY LTD., North Strathfield NSW (AU)

(21) Appl. No.: 13/012,690

(22) Filed: Jan. 24, 2011

Related U.S. Application Data
(63) Continuation-in-part of application No. 12/112,774, filed on Apr. 30, 2008.
(60) Provisional application No. 60/998,810, filed on Oct. 12, 2007.
(60) Provisional application No. 60/999,813, filed on Oct. 18, 2007.
(60) Provisional application No. 61/298,166, filed on Jan. 25, 2010.

(51) Int. Cl. G06F 17/30

(52) U.S. Cl. 707/723; 707/769; 707/722; 707/E17.009; 707/E17.014

(57) ABSTRACT

A method, computer-readable medium, and a computer system for performing a search are disclosed. Embodiments of the present invention provide a convenient and efficient mechanism for performing a search based on search data, where the search data may include a search query and at least one semantic key. The semantic key may be used to determine at least one document. Results from the search may be filtered using the at least one document. In this manner, more relevant search results may be returned.

### RELATED APPLICATIONS

The present application is a continuation-in-part of U.S. patent application Ser. No. 12/112,774, filed Apr. 30, 2008, entitled “SYSTEM AND METHOD FOR ENHANCING SEARCH RELEVANCY USING SEMANTIC KEYS,” naming Hong Liang Qiao as the inventor, and having attorney docket number LEXE-P001, which claims the benefit of U.S. Provisional Patent Application No. 60/998,810, filed Oct. 12, 2007, entitled “SYSTEM AND METHOD FOR ENHANCING SEARCH RELEVANCY WITH SEMANTIC KEYS,” naming Hong Liang Qiao as the inventor, and having attorney docket number LEXE-P001.PRO, and which also claims the benefit of U.S. Provisional Patent Application No. 60/999,813, filed Oct. 18, 2007, entitled “SYSTEM AND METHOD FOR ENHANCING SEARCH RELEVANCY WITH SEMANTIC KEYS,” naming Hong Liang Qiao as the inventor, and having attorney docket number LEXE-P001.PRO.2. Those applications are incorporated herein by reference in their entirety and for all purposes.

The present application also claims the benefit of U.S. Provisional Patent Application No. 61/298,166, filed Jan. 25, 2010, entitled “SYSTEM AND METHOD FOR ENHANCING SEARCH RELEVANCY USING SEMANTIC KEYS,” naming Hong Liang Qiao as the inventor, and having attorney docket number LEXEP001PR. That application is incorporated herein by reference in its entirety and for all purposes.

### BACKGROUND OF THE INVENTION

Conventional search engines commonly use keywords from a user-input search query to locate and display webpages. For example, if a user were interested in learning about which countries border the United States, the user may enter a search query of “country bordering United States.” In response, a conventional search engine may return webpages with all or some of the four words “country,” “bordering,” “United,” and “States.”

However, such a query would likely return a large number (e.g., tens of millions) of irrelevant or undesired webpages. For example, the results may contain webpages about country music in the United States, general information about the Unites States, etc. As such, users generally perform overly restrictive searches to narrow the number of results to a more manageable amount, thereby excluding many relevant webpages from the results. Thus, finding relevant information on the Internet using conventional keyword-based search engines is a tedious and time-consuming undertaking.

Additionally, the number of relevant results returned by conventional search engines is further limited by the literal nature of the conventional keyword search methodology. For example, webpages may use synonyms or other words related to the keywords entered in the search query, but not use one or more of the exact keywords. In this case, conventional keyword-based search engines may not return these webpages, especially where a more restrictive search is used (e.g., using an “and” operator, or the like, between keywords of the search query). Accordingly, searching for relevant information using conventional search engines is made even more cumbersome given the literal nature of conventional keyword searches.

Also, some conventional search engines perform a ranking on the identified results based on a relevance of each webpage to the entered keywords. While this may reorganize the identified results, it does not solve the above-mentioned problems of irrelevant results and other problems associated with the literal nature of conventional keyword-based search engines.

### SUMMARY OF THE INVENTION

Accordingly, a need exists for a search engine and search methodology which returns more relevant results. A need also exists for a search engine and search methodology which enables a broader search to be performed while reducing the number of irrelevant results. Additionally, a need exists for a search engine which returns relevant results in a less tedious and time-consuming manner. Embodiments of the present invention provide novel solutions to these needs and others as described below.

Embodiments of the present invention are directed to a method, computer-readable medium, and a computer system for performing a search. More specifically, embodiments of the present invention provide a convenient and efficient mechanism for performing a search based on search data (e.g., input by a user via a user interface), where the search data may include a search query (e.g., used to perform the search) and at least one semantic key. The semantic key may be used to determine at least one document (e.g., by indexing a semantic key database which includes at least one respective document corresponding to each semantic key and/or each semantic sub-key). Results from the search (e.g., including documents such as webpages, electronic documents or files, advertising content, etc.) may be filtered using the at least one document (e.g., by removing documents from the search results that are not associated with the at least one document). In this manner, more relevant search results may be returned.

In one embodiment, a computer-implemented method of performing a search includes accessing search data comprising a semantic key and a search query, wherein the search data is derived from user input via a user interface. At least one document associated with the semantic key is determined. The search may be performed based on the search query to generate search results.

In another embodiment, a computer-readable medium may have computer-readable program code embodied therein for causing a computer system to perform a method of performing a search. And in yet another embodiment, a system may include a processor and a memory, wherein the memory includes instructions that when executed by the system implement a method of performing a search.

### BRIEF DESCRIPTION OF THE DRAWINGS

The present invention is illustrated by way of example, and not by way of limitation, in the figures of the accompanying drawings and in which like reference numerals refer to similar elements.

FIG. 1 shows an exemplary system for implementing a search engine in accordance with one embodiment of the present invention.

FIG. 2 shows an exemplary flow diagram of a computer-implemented process for performing webpage searches in accordance with one embodiment of the present invention.

FIG. 3 shows an exemplary data flow diagram of the performance of webpage searches in accordance with one embodiment of the present invention.

FIG. 4 shows an exemplary flow diagram of a computer-implemented process for determining a semantic key based upon a focus of a search query in accordance with one embodiment of the present invention.

FIG. 5 shows an exemplary organization of semantic sub-keys in accordance with one embodiment of the present invention.

FIG. 6 shows an exemplary organization of semantic sub-keys associated with numerical expressions in accordance with one embodiment of the present invention.

FIG. 7A shows an exemplary flow diagram of a computer-implemented process for filtering webpage search results in accordance with one embodiment of the present invention.

FIG. 7B shows an exemplary block diagram depicting a webpage search filtering mechanism in accordance with one embodiment of the present invention.

FIG. 8A shows an exemplary flow diagram of a computer-implemented process for filtering webpage search results using text generated from keyword search results in accordance with one embodiment of the present invention.

FIG. 8B shows an exemplary block diagram depicting a webpage search filtering mechanism using text generated from keyword search results in accordance with one embodiment of the present invention.

FIG. 9 shows an exemplary flow diagram of a computer-implemented process for ranking webpage search results in accordance with a semantic sub-key frequency in accordance with one embodiment of the present invention.

FIG. 10 shows an exemplary flow diagram of a computer-implemented process for ranking webpage search results in accordance with a keyword frequency in accordance with one embodiment of the present invention.

FIG. 11 shows an exemplary flow diagram of a computer-implemented process for ranking webpage search results in accordance with a proximity of semantic sub-keys and search query keywords in accordance with one embodiment of the present invention.

FIG. 12 shows an exemplary word sequential ordering of webpage content which may be used to determine proximity between two portions of the webpage in accordance with one embodiment of the present invention.

FIG. 13 shows an exemplary on-screen graphical user interface for performing webpage searches in accordance with one embodiment of the present invention.

FIG. 14 shows an exemplary on-screen graphical user interface for performing webpage searches with search results displayed in accordance with one embodiment of the present invention.

FIG. 15 shows an exemplary data flow diagram of the performance of a search in accordance with one embodiment of the present invention.

FIG. 16 shows an exemplary flow diagram of a computer-implemented process for creating a semantic key database in accordance with one embodiment of the present invention.

FIG. 17 shows an exemplary table of semantic keys and semantic sub-keys in accordance with one embodiment of the present invention.

FIG. 18 shows an exemplary inverted index in accordance with one embodiment of the present invention.

FIG. 19 shows an exemplary semantic key database in accordance with one embodiment of the present invention.

FIG. 20 shows an exemplary flow diagram of a computer-implemented process for performing a search in accordance with one embodiment of the present invention.

FIG. 21 shows an exemplary user interface for performing a search in accordance with one embodiment of the present invention.

FIG. 22 shows an exemplary data flow diagram of the performance of a search using a search data processor in accordance with one embodiment of the present invention.

FIG. 23 shows an exemplary flow diagram of a computer-implemented process for modifying a search query to further include at least one semantic sub-key in accordance with one embodiment of the present invention.

FIG. 24 shows an exemplary semantic key database including at least one attribute in accordance with one embodiment of the present invention.

FIG. 25 shows an exemplary flow diagram of a computer-implemented process for modifying a search query to further include a semantic key or a portion thereof in accordance with one embodiment of the present invention.

FIG. 26A shows a first view of an exemplary on-screen graphical user interface depicting an automated completion or suggestion of a semantic keyword in accordance with one embodiment of the present invention.

FIG. 26B shows a second view of an exemplary on-screen graphical user interface depicting an automated completion or suggestion of a semantic keyword in accordance with one embodiment of the present invention.

FIG. 27 shows an exemplary on-screen graphical user interface for presenting search results in accordance with one embodiment of the present invention.

FIG. 28 shows an exemplary flow diagram of a computer-implemented process for performing a search based on an altered search query in accordance with one embodiment of the present invention.

FIG. 29 shows an exemplary data flow diagram of the performance of a search using a modified search query in accordance with one embodiment of the present invention.

FIG. 30 shows an exemplary computer system platform upon which embodiments of the present invention may be implemented.

### DETAILED DESCRIPTION OF THE INVENTION

Reference will now be made in detail to embodiments of the present invention, examples of which are illustrated in the accompanying drawings. While the present invention will be discussed in conjunction with the following embodiments, it will be understood that they are not intended to limit the present invention to these embodiments alone. On the contrary, the present invention is intended to cover alternatives, modifications, and equivalents which may be included with the spirit and scope of the present invention as defined by the appended claims. Furthermore, in the following detailed description of the present invention, numerous specific details are set forth in order to provide a thorough understanding of the present invention. However, embodiments of the present invention may be practiced without these specific details. In other instances, well-known methods, procedures, components, and circuits have not been described in detail so as not to unnecessarily obscure aspects of the present invention.

### Notation and Nomenclature

Some regions of the detailed descriptions which follow are presented in terms of procedures, logic blocks, processing and other symbolic representations of operations on data bits within a computer memory. These descriptions and representations are the means used by those skilled in the data processing arts to most effectively convey the substance of their work to others skilled in the art. In the present application, a procedure, logic block, process, or the like, is conceived to be a self-consistent sequence of steps or instructions leading to a desired result. The steps are those requiring physical manipulations of physical quantities. Usually, although not necessarily, these quantities take the form of electrical or magnetic signals capable of being stored, transferred, combined, compared, and otherwise manipulated in a computer system.

It should be borne in mind, however, that all of these and similar terms are to be associated with the appropriate physical quantities and are merely convenient labels applied to these quantities. Unless specifically stated otherwise as apparent from the following discussions, it is appreciated that throughout the present invention, discussions utilizing the terms such as “aborting,” “accepting,” “accessing,” “adding,” “adjusting,” “analyzing,” “applying,” “assembling,” “assigning,” “balancing,” “blocking,” “calculating,” “capturing,” “combining,” “comparing,” “collecting,” “creating,” “debugging,” “defining,” “depicting,” “detecting,” “determining,” “displaying,” “establishing,” “executing,” “filtering,” “flipping,” “generating,” “grouping,” “hiding,” “identifying,” “initiating,” “interacting,” “modifying,” “monitoring,” “moving,” “outputting,” “performing,” “placing,” “presenting,” “processing,” “programming,” “querying,” “ranking,” “removing,” “repeating,” “resuming,” “sampling,” “simulating,” “sorting,” “storing,” “subtracting,” “suspending,” “tracking,” “transcoding,” “transforming,” “unblocking,” “using,” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

### Embodiments of the Invention

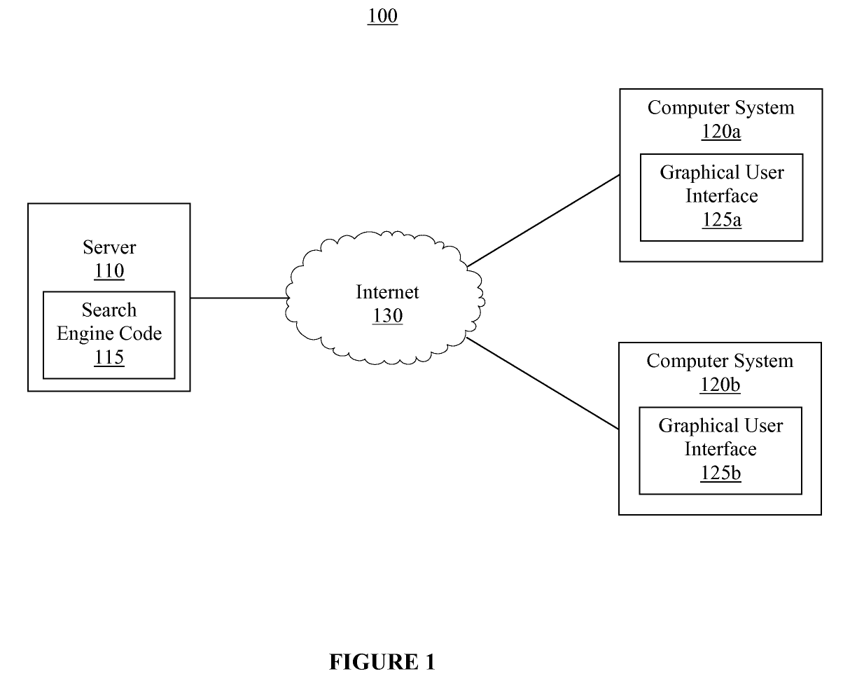

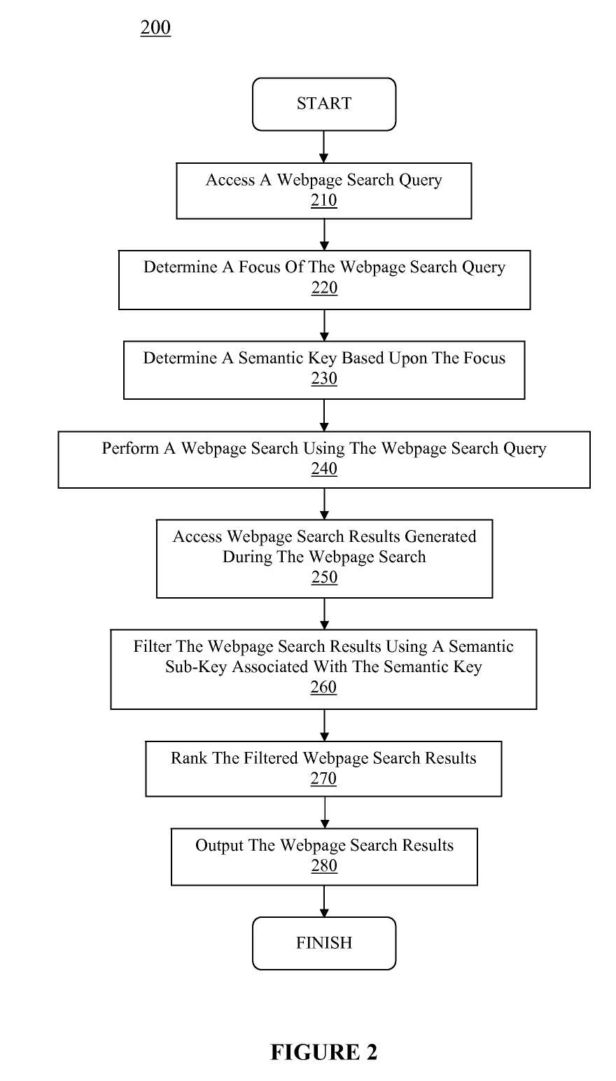

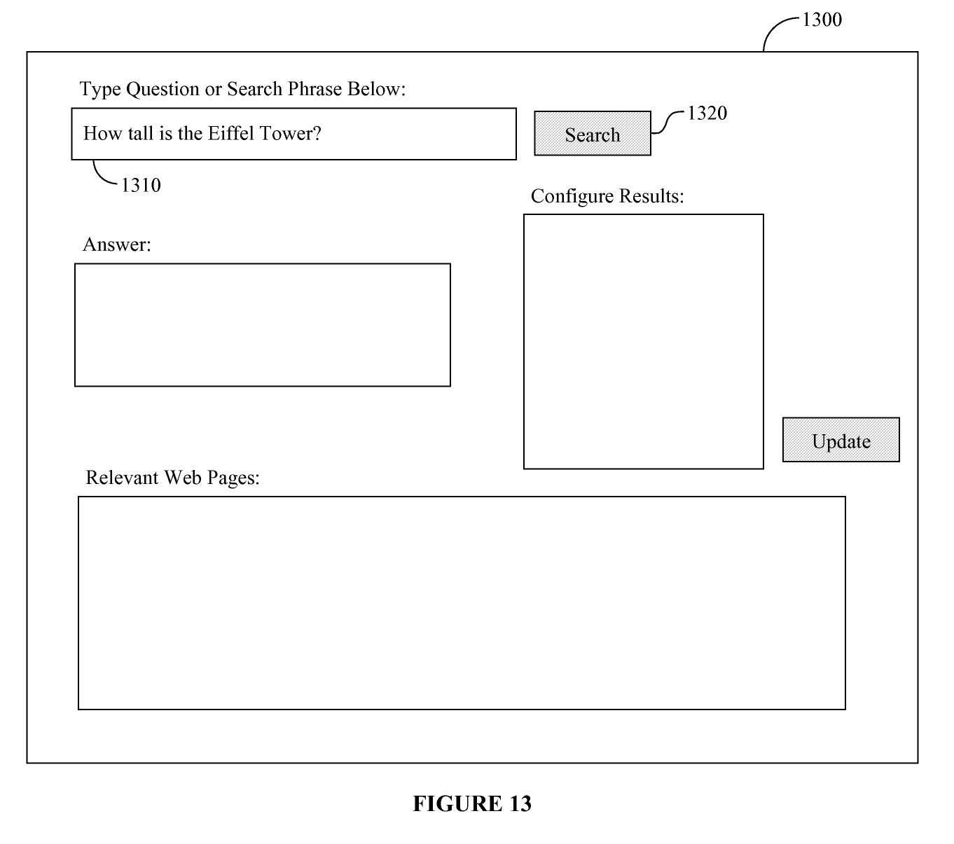

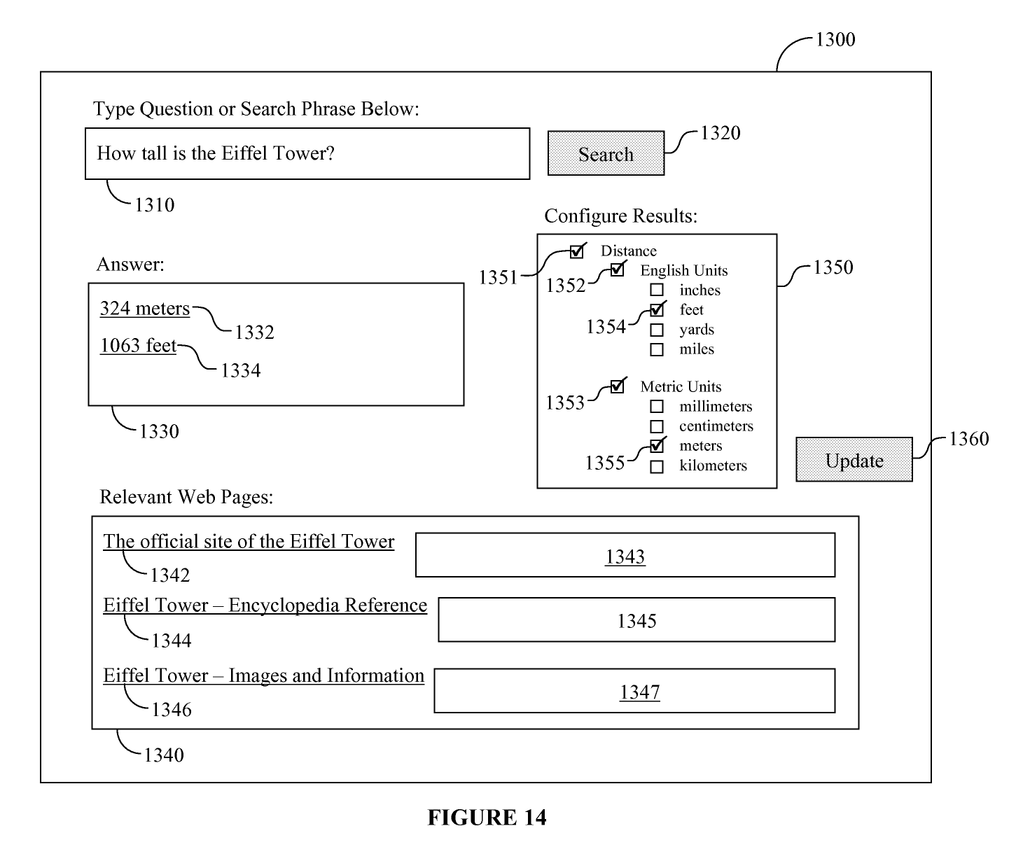

FIG. 1 shows exemplary system 100 for implementing a search engine (e.g., an Internet-based search engine) in accordance with one embodiment of the present invention. As shown in FIG. 1, server 110 may comprise search engine code 115 for implementing a process of searching for webpages (e.g., in accordance with 200 of FIG. 2). Server 110 may communicate with one or more computer systems (e.g., 120a, 120b, etc.) via Internet 130 in one embodiment, thereby enabling the search engine code (e.g., 115) to communicate with one or more graphical user interfaces (e.g., 125a of computer system 120a, 125b of computer system 120b, etc.). The graphical user interfaces (e.g., 125a, 125b, etc.) may communicate inputs (e.g., search queries input by a user, commands to initiate a webpage search, etc.) to the search engine code (e.g., 115), and may also display or otherwise present outputs (e.g., results of the webpage search, etc.) received from search engine code. In this manner, the graphical user interfaces (e.g., 125a, 125b, etc.) may implement a graphical user interface (e.g., 1300 of FIGS. 13 and 14) for performing searches of webpages.

Although FIG. 1 shows only two computer systems (e.g., 120a and 120b), it should be appreciated that a larger or smaller number of computer systems may be used in other embodiments. It should also be appreciated that one or more networks, network device, etc. may be coupled to or otherwise used to implement communication between components of system 100 (e.g., server 110, computer system 120a, computer system 120b, etc.). It should also be appreciated that server 110 may communicate with coupled computer systems (e.g., 120a, 120b, etc.) via an intranet (e.g., in place of internet 130, in addition to internet 130, etc.) in one embodiment. Additionally, although only one server (e.g., 110) is depicted in FIG. 1, it should be appreciated that system 100 may comprise a larger number of servers in other embodiments. Further, it should be appreciated that system 100 may comprise additional components (e.g., one or more memories coupled to internet 130 and/or directly to sever 110 for storing search engine code 115, for storing data accessed by server 110 and/or search engine code 115, etc.) in other embodiments.

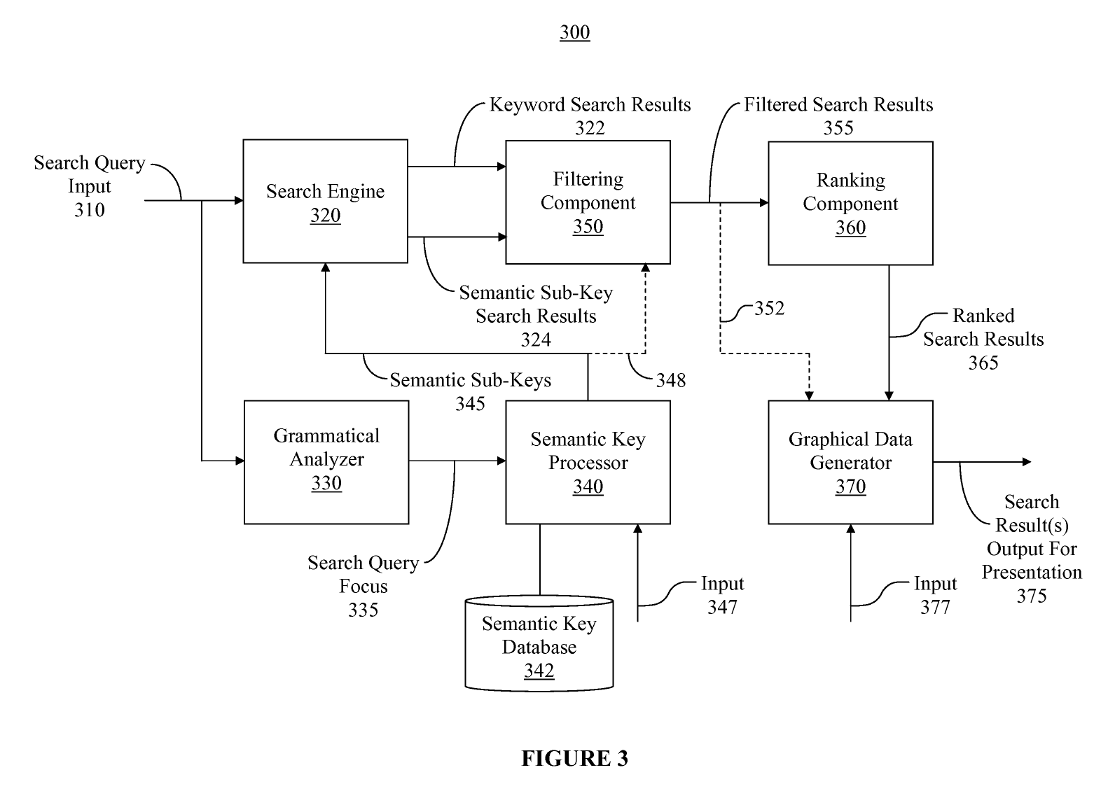

FIG. 2 shows an exemplary flow diagram of computer-implemented process 200 for performing webpage searches in accordance with one embodiment of the present invention. As the steps of process 200 are described herein, reference will be made to exemplary data flow diagram 300 of FIG. 3, and to system 100 of FIG. 1, to provide examples and help clarify the discussion.

Turning briefly to FIG. 3, a broad keyword search may be performed by search engine 320, where the results from the broad keyword search may be subsequently filtered by filtering component 350. Filtering component 350 may filter the search results based upon one or more semantic keys (e.g., accessed from semantic key database 342) determined based upon a focus of the search query (e.g., used by search engine 320 to perform the broad keyword search), where the one or more semantic keys may have at least one associated semantic sub-key. Accordingly, the broad keyword search may provide more complete search results (e.g., omitting fewer relevant search results) which may then be filtered (e.g., by filtering component 350) to reduce the number of irrelevant search results and provide more relevant search results. The search results may then be ranked (e.g., by ranking component 360) in one embodiment, thereby generating ranked search results which are more complete and relevant than those produced by conventional search engines.

As shown in FIG. 2, step 210 involves accessing a webpage search query. The webpage search query (e.g., 310) may be input to a search engine (e.g., 320) in one embodiment. The search query (e.g., 310) may comprise at least one word and/or at least one phrase. Additionally, in one embodiment, the search query (e.g., 310) may comprise at least one operator (e.g., “and,” “or,” etc.) and/or other data for controlling the search performed by the search engine (e.g., 320).

Step 220 involves determining a focus of the webpage search query. Step 220 may be performed by a grammatical analyzer (e.g., 330) operable to access the search query (e.g., 310) and output a search query focus (e.g., 335) in one embodiment. The focus of the search query may comprise a keyword or phrase of the search query which relates to the information desired by the user inputting the search query. Additionally, where the search query is a question, the focus of the query may comprise a keyword or phrase of the search query which may be used to determine the form and/or content of an answer. For example, if the search query were the question “how tall is the Eiffel Tower,” then the focus of the search query may be determined to be the keyword “tall” which relates to a distance. As such, the answer may comprise a distance relating to the height of the Eiffel Tower. As another example, if the search query were the question “which countries border the United States,” then the focus of the search query may be determined to be the keyword “countries.” As such, the answer may comprise a listing of countries which border the United States.

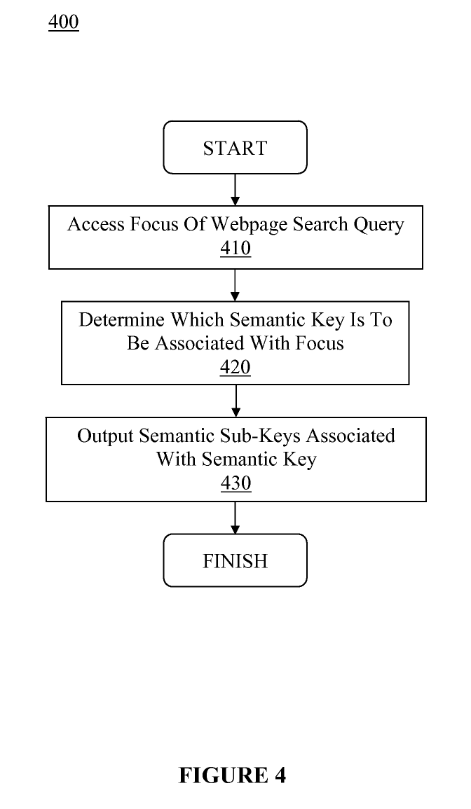

As shown in FIG. 2, step 230 involves determining a semantic key based upon the focus. In one embodiment, step 230 may be performed in accordance with process 400 of FIG. 4. As shown in FIG. 4, step 410 involves accessing a focus (e.g., 335) of a webpage search query (e.g., 310). Step 420 involves determining which semantic key is to be associated with the focus. The semantic key may be determined (e.g., by semantic key generator 340) by comparing the focus (e.g., 335) with possible semantic keys (e.g., stored in semantic key database 342) in one embodiment. Upon finding a match between the focus (e.g., 335) and a semantic key (e.g., 510), or an association between the two, the matched and/or associated semantic key (e.g., 510) may be designated as the semantic key for that focus.

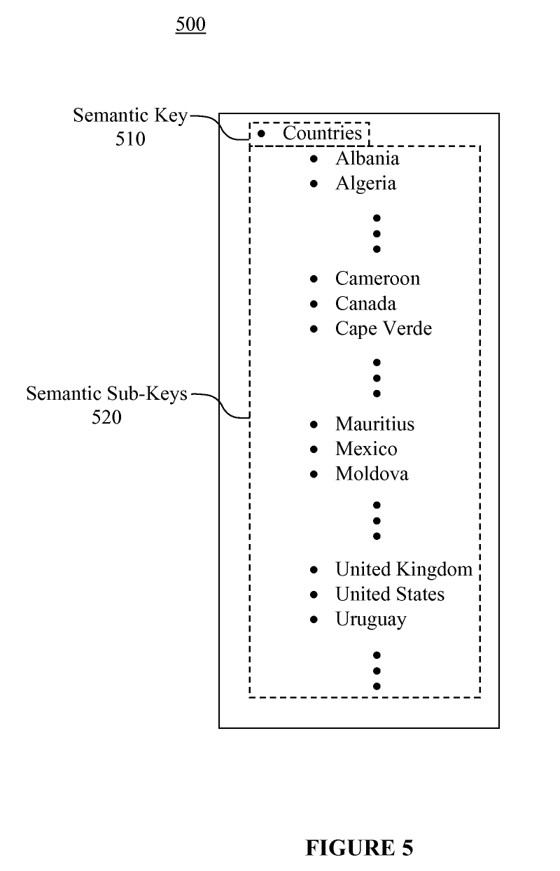

For example, if the focus (e.g., 335) is “country,” then a semantic key (e.g., 510 as shown in FIG. 5) associated with a list of countries (e.g., semantic sub-keys 520) may be associated with the focus (e.g., 335). The semantic key (e.g., 510) and/or related semantic sub-keys (e.g., 520) may be organized in a hierarchy with one or more nodes (e.g., semantic key 510 is a superior or parent node, while semantic sub-keys 520 are child nodes of the parent node associated with semantic key 510) in one embodiment. Further, one or more of the semantic sub-keys (e.g., 520) may comprise a hyponym (e.g., semantic key 510 comprises the heading “countries” while semantic sub-keys 520 comprise a listing or index of countries) of a semantic key (e.g., 510).

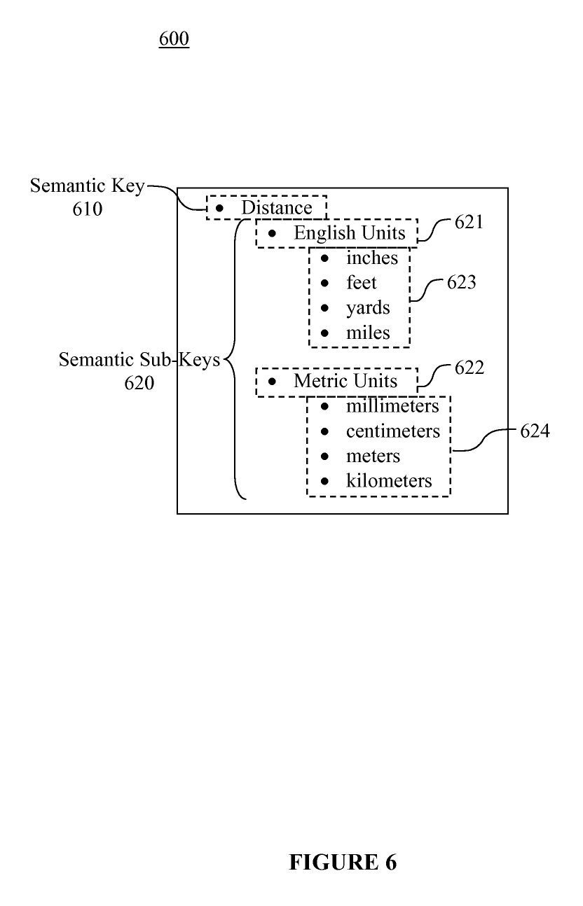

As another example, if the focus (e.g., 335) is “tall,” then a semantic key (e.g., 610 as shown in FIG. 6) associated with distance (e.g., semantic sub-keys 620) may be associated with the focus (e.g., 335). The semantic key (e.g., 510) and/or related semantic sub-keys (e.g., 520) may be organized in a hierarchy with one or more nodes (e.g., semantic key 610 is a superior or parent node of semantic sub-keys 620, semantic sub-key 621 is a superior or parent node of semantic sub-keys 623, and semantic sub-key 622 is a superior or parent node of semantic sub-keys 624) in one embodiment. Further, one or more of the semantic sub-keys (e.g., 620) may comprise a hyponym (e.g., semantic key 610 comprises the heading “distance” while semantic sub-keys 620 comprise different units of distance) of a semantic key (e.g., 610).

In one embodiment, step 420 may involve determining at least one alternative version of a semantic key. For example, the semantic key “nation” could be determined in step 420 for the semantic key “country.” As another example, the semantic keys “cost,” “expense” and/or “money” could be determined for the semantic key “price.”

In one embodiment, semantic keys and semantic sub-keys may include other types of data. For example, “email address” (e.g., “electronic mail address” or the like) may be a semantic key, where the corresponding semantic sub-keys may include at least one email address. As another example, “address” (e.g., a physical address including a street name, street number, city, state, nation, etc.) may be a semantic key, where the corresponding semantic sub-keys may include at least one address. As yet another example, “phone number” (e.g., a telephone number, cellular phone number, etc.) may be a semantic key, where the corresponding semantic sub-keys may include at least one phone number. As a further example, “fax number” (e.g., “facsimile number” or the like) may be a semantic key, where the corresponding semantic sub-keys may include at least one fax number. And as another example, a semantic key may be a concept (e.g., significance, meaning, reason/cause, sentiment, a positive word, a negative word, location, a method, etc.), where the corresponding semantic sub-keys may include at least one word related to the concept.

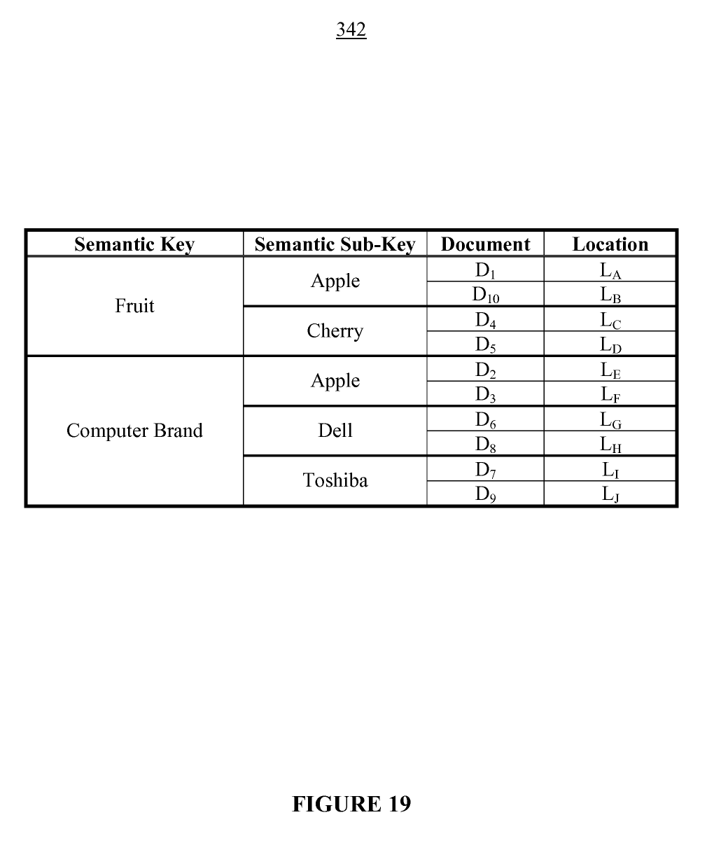

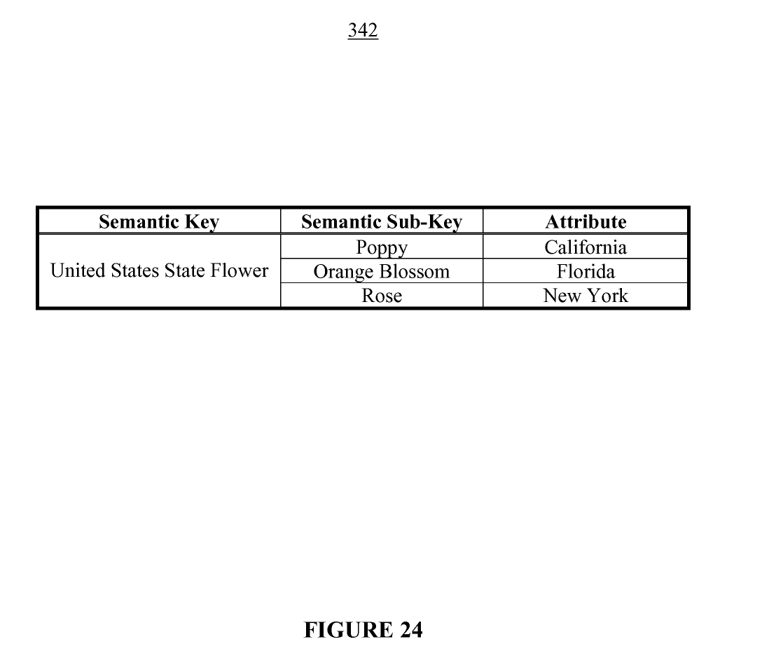

In one embodiment, a semantic sub-key may be determined in step 420 by indexing semantic key database 342 using a semantic key (e.g., determined based on search query focus 335). Semantic key database 342 may include at least one respective semantic sub-key corresponding to each semantic key. Semantic key database 342 may also include at least one respective document (e.g., a webpage, electronic document or file, advertising content, etc.) or identifier thereof corresponding to each semantic key and/or each semantic sub-key (e.g., as shown in FIG. 19). In one embodiment, semantic key database 342 may include at least one respective location (e.g., within a document) corresponding to each semantic key and/or each semantic sub-key (e.g., as shown in FIG. 19). And in one embodiment, semantic key database 342 may include at least one respective attribute corresponding to each semantic key and/or each semantic sub-key (e.g., as shown in FIG. 24).

As shown in FIG. 4, step 430 involves outputting semantic sub-keys (e.g., 520, 620, etc.) associated with the semantic key (e.g., 510, 610, etc.) determined in step 420. The semantic sub-keys (e.g., 345) may be output by a semantic key generator (e.g., 340) as shown in FIG. 3. Additionally, in one embodiment, semantic sub-keys 345 may comprise one or more of semantic sub-keys 520 and/or 620 (e.g., depending upon the at least one respective semantic key assigned to the focus (e.g., 335) of the search query (e.g., 310).

The semantic sub-keys (e.g., 345) output by the semantic key processor (e.g., 340) may be controlled by input 347 in one embodiment. Input 347 may comprise a user input, system-generated input, etc. For example, inputs 347 may select at least one semantic key (e.g., 510, 610, etc.) and/or at least one semantic sub-key (e.g., 345, 520, 620, etc.) for output by semantic key processor 340, where the selection of the semantic sub-keys may be input to a graphical user interface (e.g., 125a, 125b, etc.) in one embodiment. As such, inputs 347 may enable a user to configure and/or refine the search query (e.g., 310) in one embodiment, thereby further enabling a user to configure or refine the searches performed by search engine 320 as discussed below.

Turning back to FIG. 2, step 240 involves performing a webpage search using the webpage search query (e.g., accessed in step 210). The webpage search may comprise a keyword search (e.g., based upon one or more keywords of the search query). And in one embodiment, the webpage search may comprise a keyword search of any well-known fashion. Additionally, the search may be performed by a search engine (e.g., 320) operable to access the search query (e.g., 310) and output search results (e.g., keyword search results 322). In one embodiment, the webpage search may be performed by any well-known, keyword-based search engine. The search engine (e.g., 322) may be implemented by search engine code (e.g., 115 of FIG. 1), and the search query (e.g., 310) may be input to a graphical user interface (e.g., 125a, 125b, etc.) and communicated to a computer system (e.g., server 110) which accesses and/or executes the search engine code (e.g., 115).

Step 250 involves accessing the webpage search results generated during the webpage search (e.g., performed in step 240). The webpage search results (e.g., keyword search results 322) may be accessed by a filtering component (e.g., 350) in one embodiment.

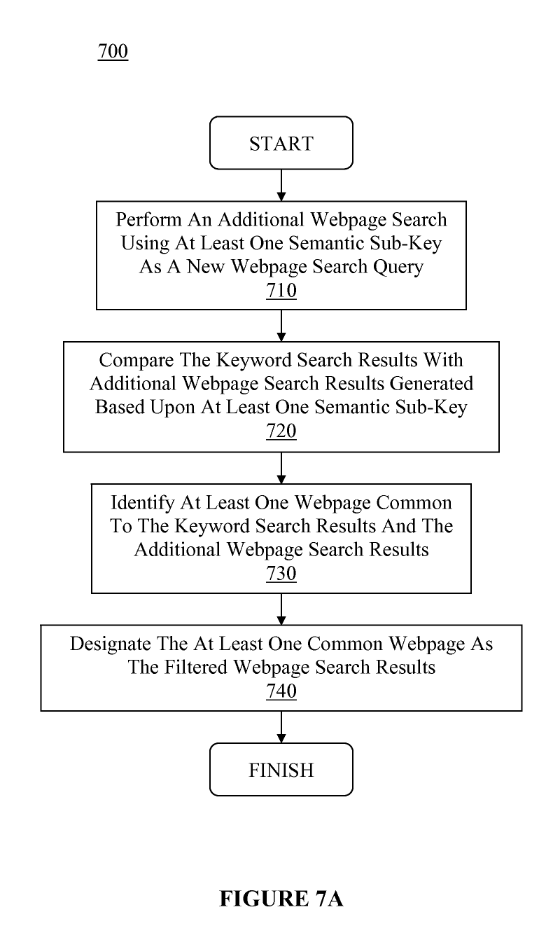

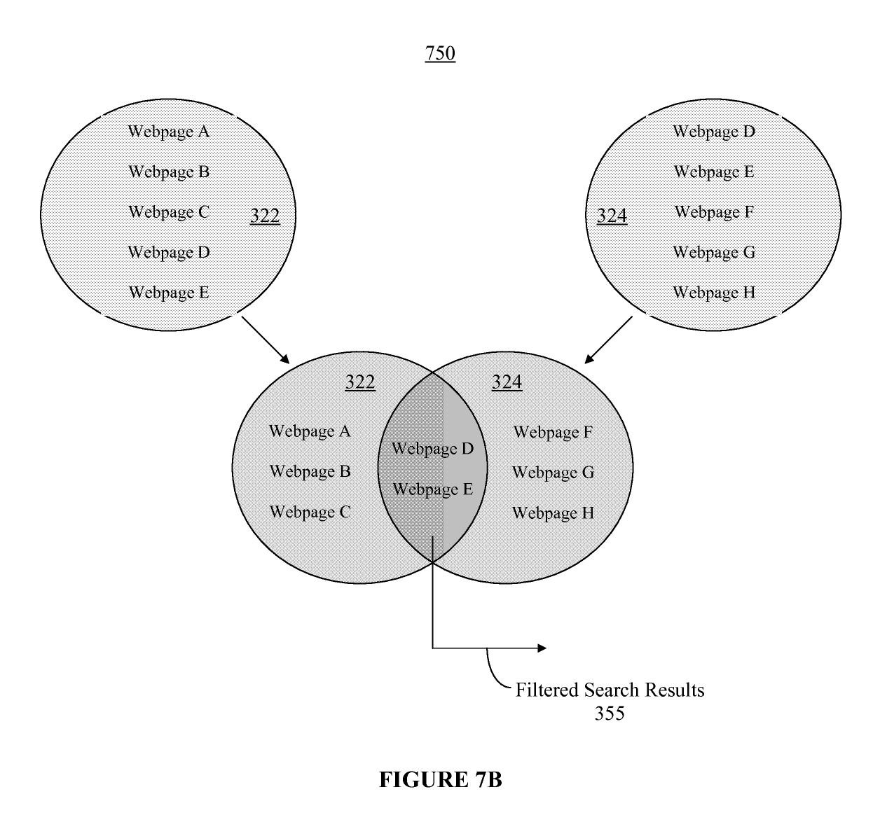

As shown in FIG. 2, step 260 involves filtering the webpage search results (e.g., 322) using a semantic sub-key (e.g., 345, 520, 620, etc.) associated with the semantic key (e.g., determined in step 230). In one embodiment, step 260 may be performed in accordance with process 700 of FIG. 7A. As shown in FIG. 7A, step 710 involves performing an additional webpage search using at least one semantic sub-key (e.g., 345, 520, 620, etc.) as a new webpage search query. The additional webpage search may be performed by a search engine (e.g., 320) operable to access the at least one semantic sub-key (e.g., 345, 520, 620, etc.) and generate the additional webpage search results (e.g., semantic sub-key search results 324).

Keyword search results (e.g., 322) may be compared with the additional webpage search results (e.g., 324) generated based upon the at least one semantic sub-key (e.g., 345, 520, 620, etc.). Step 730 involves identifying at least one webpage common to the keyword search results (e.g., 322) and the additional webpage search results (e.g., 324). Steps 720 and 730 may be performed by a filtering component (e.g., 350) operable to access the keyword search results (e.g., 322) and the additional webpage search results (e.g., 324) in one embodiment.

As shown in FIG. 7A, step 740 involves designating the at least one common webpage as the filtered webpage search results (e.g., those generated as a result of the filtering in step 260). In one embodiment, the filtered webpage search results (e.g., 355) may be output by a filtering component (e.g., 350). In this manner, embodiments may filter irrelevant webpages (e.g., those not comprising at least one semantic sub-key) from the search results (e.g., 355), while maintaining the relevant webpages (e.g., those which comprise at least one semantic sub-key).

Although the filtering performed in step 260 has been described in terms of the steps of exemplary process 700, it should be appreciated that other filtering mechanisms may be performed in other embodiments. For example, each webpage of the results of the keyword search (e.g., 322) may be searched for the semantic sub-keys (e.g., 345, 520, 620, etc.). If a webpage does not contain at least one of the semantic sub-keys (e.g., 345, 520, 620, etc.), then the webpage may be discarded or excluded from the filtered webpage search results (e.g., 355) in one embodiment. In this manner, the filtered webpage search results (e.g., 355) may comprise webpages which contain at least one of the semantic sub-keys (e.g., 345, 520, 620, etc.). Alternatively, other filtering mechanisms may be used in other embodiments to strip irrelevant webpages (e.g., those not intended or desired by search query 310) while maintaining relevant webpages (e.g., those intended or desired by search query 310).

FIG. 7B shows exemplary block diagram 750 depicting a webpage search filtering mechanism in accordance with one embodiment of the present invention. As shown in FIG. 7B, search results 322 may comprise webpages A through E, while search results 324 comprise webpages D through H. In one embodiment, keyword search results 322 may include webpages identified, located, etc. in response to a keyword search. Additionally, semantic sub-key search results 324 may include webpages identified, located, etc. in response to a webpage search with a search query including one or more semantic sub-keys (e.g., 345, 520, 620, etc.).

Search results 322 may then be filtered by comparing search results 322 and 324 (e.g., as described in step 720 of process 700 of FIG. 7A) and identifying at least one webpage shared by both search results 322 and 324 (e.g., as described in step 730 of process 700 of FIG. 7A). As depicted in FIG. 7B, the comparison of search results 322 with search results 324 may be depicted by the overlapping of the search results (e.g., 322 and 324). The overlapped area (e.g., comprising webpage D and E) may indicate that webpages D and E are members of both search results 322 and search results 324. Once the webpages (e.g., webpages D and E) shared by both search results 322 and 324 are identified, they may be designated as filtered search results 355 (e.g., as described with respect to step 740 of process 700 of FIG. 7A).

It should be appreciated that search results 322 and/or search results 324 may comprise an aggregation of one or more subsets of search results. For example, where multiple semantic sub-key searches are performed (e.g., where a semantic key associated with focus 335 of search query 310 has more than one semantic sub-key 345 associated therewith), the search results from each search may be combined. For example, search results 324 may comprise search results from a first semantic sub-key search (e.g., using a first semantic sub-key as the search query), search results from a second semantic sub-key search (e.g., using a second semantic sub-key as the search query), and search results from a third semantic sub-key search (e.g., using a third semantic sub-key as the search query). In other embodiments, a larger or smaller number of search results may be combined to form search results 324. In this manner, each webpage of the output search results (e.g., 355) may comprise at least one semantic sub-key (e.g., 345, 520, 620, etc.), thereby increasing the number of relevant results given the association (e.g., via the semantic key) of the semantic sub-key (e.g., 345) to the focus (e.g., 355) of the search query (e.g., 310).

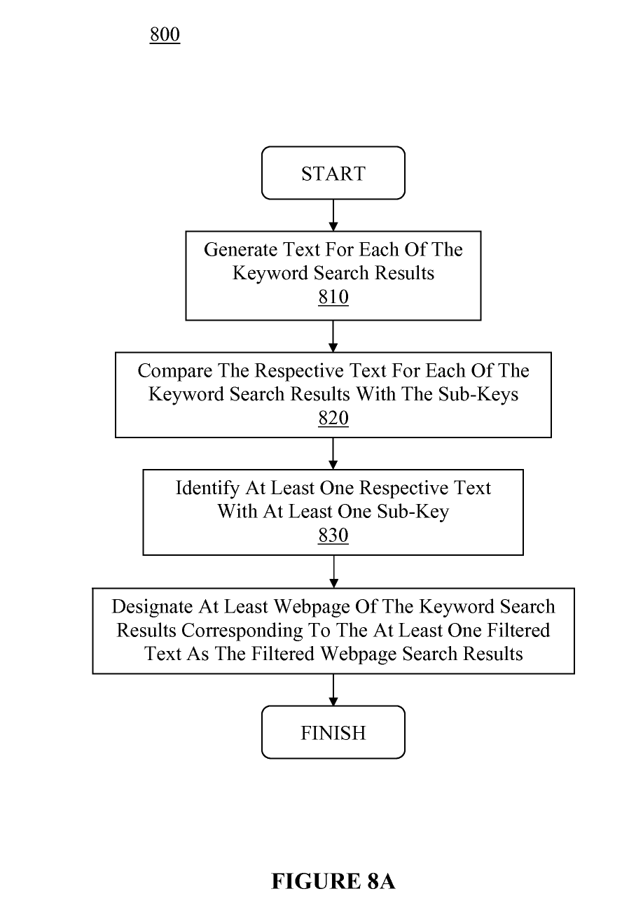

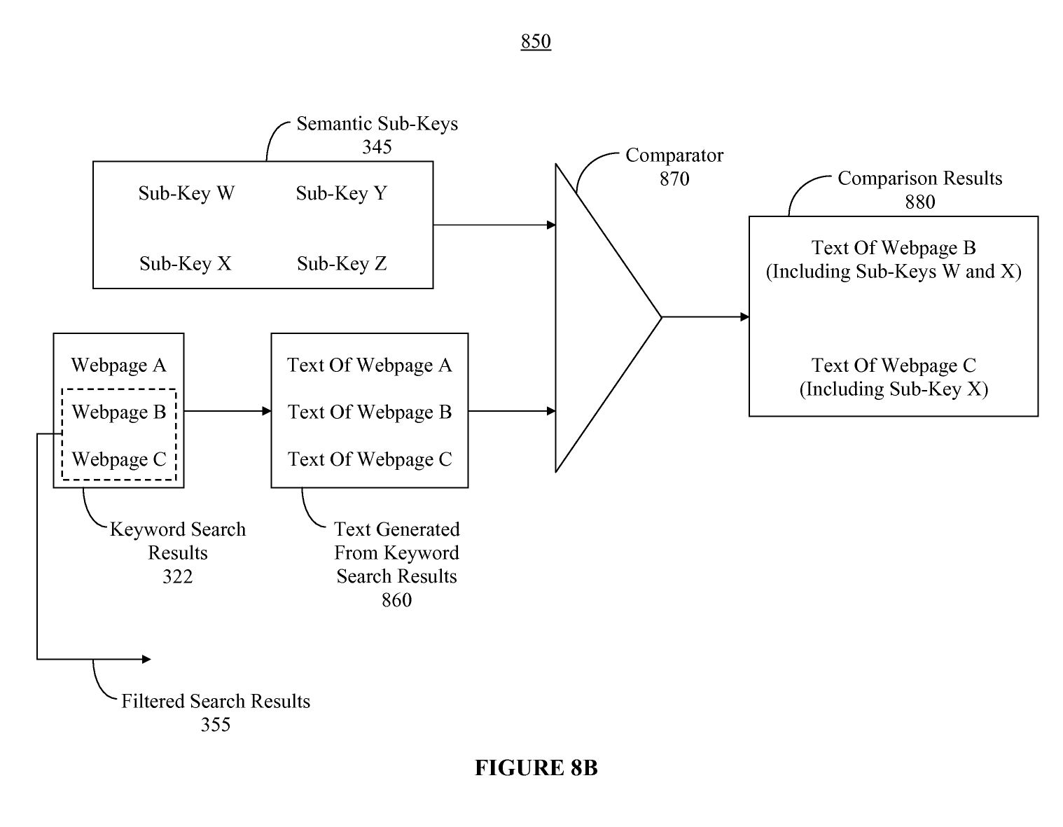

Turning back to FIG. 2, step 260 may be performed in accordance with process 800 of FIG. 8A in one embodiment. FIG. 8B will be described in conjunction with FIG. 8A below.

As shown in FIG. 8A, step 810 involves generating text for each of the keyword search results (e.g., 322). The text (e.g., 860) may be generated by a filtering component (e.g., 350) in one embodiment. Additionally, the text (e.g., 860) may comprise a title of the at least one webpage of the keyword search results (e.g., 322), portions of the bodies or content of the at least one webpage of the keyword search results (e.g., 322), an identifier or other reference to the at least one webpage of the keyword search results (e.g., 322), some combination thereof, etc. For example, as shown in FIG. 8B, text 860 may include text for each of webpages A through C of keyword search results 322.

Step 820 involves comparing the respective text for each of the keyword search results with the sub-keys. For example, as shown in FIG. 8B, semantic sub-keys 345 may include sub-keys W through Z which may be compared (e.g., by comparator 870) to the text (e.g., 860) generated based from the keyword search results (e.g., 322). Comparator 870 may be implemented by filtering component 350 (e.g., which accesses semantic sub-keys 345 from semantic key processor 340 as depicted in FIG. 3 by dashed arrow 348) in one embodiment. The comparison may involve searching text 860 for each of sub-keys 345 individually (e.g., search text 860 for sub-key W, then search text 860 for sub-key X, etc.) until a match is found, or alternatively, may involve searching text 860 for each of sub-keys 345 in parallel (e.g., search text 860 for sub-key W through Z at the same time) to determine if a match is found. Additionally, the comparison may be a text-to-text comparison where sub-keys 345 are text.

As shown in FIG. 8A, step 830 involves identifying at least one respective text (e.g., corresponding to one or more webpages of keyword search results 322) with at least one sub-key (e.g., 345). For example, as shown in FIG. 8B, comparison results 880 (e.g., output by comparator 870) may include text associated with webpages B and C, where the text of webpage B includes sub-keys W and X and the text of webpage C includes sub-key X. The text of webpage A may not include any of sub-keys W through Z in one embodiment, and therefore, may not be included in comparison results 880. Thus, the text corresponding to webpages B and C may be identified (e.g., by comparison results 880) in step 830.

Step 840 involves designating at least one webpage of the keyword search results corresponding to the at least one filtered text as the filtered webpage search results. For example, as shown in FIG. 8B, where comparison results 880 include text for webpages B and C, then webpages B and C from keyword search results 322 may be designated as the filtered search results (e.g., 355).

And in one embodiment, step 840 may include prioritizing or otherwise ranking the designated webpages (e.g., related to or identified using comparison results 880) above other webpages of keyword search results 322 which do not include one or more of sub-keys 345. In this manner, step 840 may implement a pre-ranking step (e.g., performed before ranking in step 270 of FIG. 2). For example, referring to FIG. 8B, webpages B and C (which include one or more sub-keys 345) may be ranked ahead of webpage A (which does not include at least one of sub-keys 345). Thus, filtered search results 355 may include even webpages without at least one semantic sub-key 345 in one embodiment.

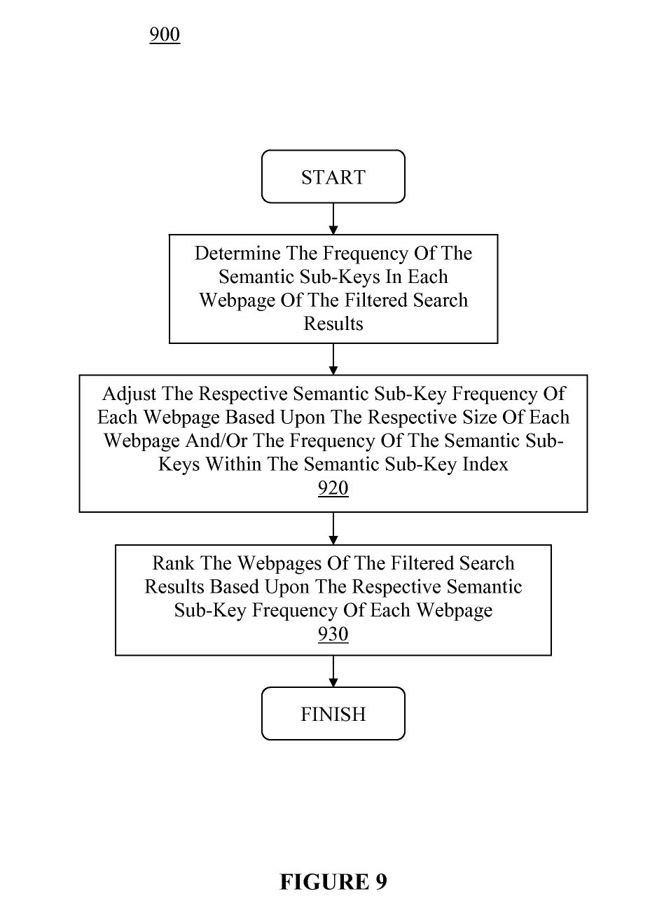

Turning back to FIG. 2, step 270 involves ranking the filtered webpage search results (e.g., 355). The filtered search results (e.g., 355) may be ranked by a ranking component (e.g., 360 of FIG. 3), thereby generating ranked search results (e.g., 365), in one embodiment. Additionally, in one embodiment, step 270 may be performed in accordance with one or more of exemplary processes 900-1100 of FIGS. 9-11, respectively.

FIG. 9 shows an exemplary flow diagram of computer-implemented process 900 for ranking webpage search results in accordance with a semantic sub-key frequency in accordance with one embodiment of the present invention. As shown in FIG. 9, step 910 involves determining the frequency of the semantic sub-keys in each webpage of the filtered search results (e.g., 355). In one embodiment, the semantic sub-key frequency for each webpage may be determined based upon the total number of instances of all semantic sub-keys (e.g., 245, 520, 620, etc.) of each webpage of the search results (e.g., 355). For example, if webpage X comprises 30 instances of semantic sub-key 1 and 40 instances of semantic sub-key 2, then the semantic sub-key frequency for webpage X may be 70 (e.g., the sum of 30 and 40) in one embodiment. Alternatively, the semantic sub-key frequency for each webpage may be determined based upon the number of instances of one or more selected semantic sub-keys (e.g., 245, 520, 620, etc.) of each webpage of the search results (e.g., 355). For example, the semantic sub-key frequency for webpage X may be 30 if semantic sub-key 1 is used to determine the semantic sub-key frequency. Alternatively, the semantic sub-key frequency for webpage X may be 40 if semantic sub-key 2 is used to determine the semantic sub-key frequency.

Step 920 involves adjusting the respective semantic sub-key frequency of each webpage based upon the respective size of each webpage and/or the frequency of the semantic sub-keys within the semantic sub-key index (e.g., stored within semantic key database 342). For example, the semantic sub-key frequency for each webpage of the search results may be scaled (e.g., divided) by a factor associated with its respective webpage size (e.g., number of words, number of lines, frame size, etc.) in one embodiment. Alternatively, the semantic sub-key frequency for each webpage of the search results may be scaled by the frequency of its respective semantic sub-key (e.g., the semantic sub-key used to produce the search results comprising the webpage) within the semantic sub-key index (e.g., the collection of semantic sub-keys associated with a given semantic key). For example, if a semantic sub-key appears three times within a given semantic sub-key index (e.g., each instance under a different sub-node within the index associated with a semantic key), then the semantic sub-key frequency for each webpage search result associated with that semantic sub-key may be scaled (e.g., divided) by a factor (e.g., three) associated with the frequency of the semantic sub-key within the semantic sub-key index. And in other embodiments, step 920 may be omitted.

As shown in FIG. 9, step 930 involves ranking the webpages of the filtered search results based upon the respective semantic sub-key frequency of each webpage. For example, if webpage X has a semantic sub-key frequency (e.g., non-scaled as determined in step 910 and/or scaled as determined in step 920) of 70, while webpage Y has a semantic sub-key frequency of 80, then webpage Y may be ranked ahead of webpage X in one embodiment. In this case, a higher semantic sub-key frequency of webpage Y may indicate that webpage Y is more relevant to the search query (e.g., 310) than webpage X in one embodiment, hence the higher ranking of webpage Y with respect to webpage X.

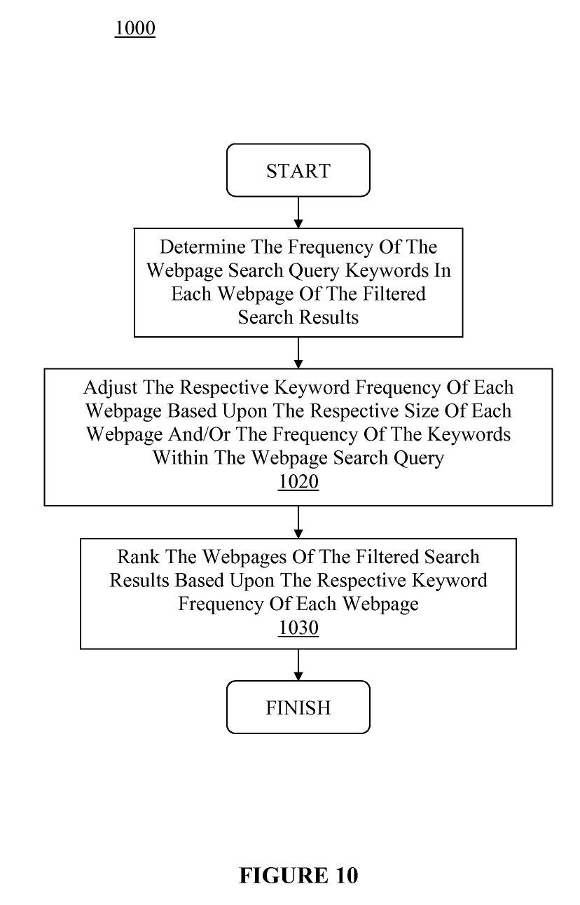

FIG. 10 shows an exemplary flow diagram of computer-implemented process 1000 for ranking webpage search results in accordance with a keyword frequency in accordance with one embodiment of the present invention. As shown in FIG. 10, step 1010 involves determining the frequency of the webpage search query keywords (e.g., of search query 310) in each webpage of the filtered search results (e.g., 355). In one embodiment, the keyword frequency for each webpage may be determined based upon the total number of instances of all search query keywords of each webpage of the search results (e.g., 355). For example, if webpage X comprises 10 instances of keyword 1 and 50 instances of keyword 2, then the keyword frequency for webpage X may be 60 (e.g., the sum of 10 and 50) in one embodiment. Alternatively, the keyword frequency for each webpage may be determined based upon the number of instances of one or more selected search query keywords of each webpage of the search results (e.g., 355). For example, the keyword frequency for webpage X may be 10 if keyword 1 is used to determine the keyword frequency. Alternatively, the keyword frequency for webpage X may be 50 if keyword 2 is used to determine the keyword frequency.

Step 1020 involves adjusting the respective keyword frequency of each webpage based upon the respective size of each webpage and/or the frequency of one or more keywords within the search query (e.g., 310). For example, the keyword frequency for each webpage of the search results may be scaled (e.g., divided) by a factor associated with its respective webpage size (e.g., number of words, number of lines, frame size, etc.) in one embodiment. Alternatively, the keyword frequency for each webpage of the search results may be scaled by the frequency of one or more keywords within the search query. For example, if a keyword appears three times within the search query, then the keyword frequency for each webpage search result comprising the keyword may be scaled (e.g., divided) by a factor (e.g., three) associated with the frequency of the keyword within the search query (e.g., 310). And in other embodiments, step 1020 may be omitted.

As shown in FIG. 10, step 1030 involves ranking the webpages of the filtered search results based upon the respective keyword frequency of each webpage. For example, if webpage X has a keyword frequency (e.g., non-scaled as determined in step 1010 and/or scaled as determined in step 1020) of 60, while webpage Y has a keyword frequency of 90, then webpage Y may be ranked ahead of webpage X in one embodiment. In this case, a higher keyword frequency of webpage Y may indicate that webpage Y is more relevant to the search query (e.g., 310) than webpage X in one embodiment, hence the higher ranking of webpage Y with respect to webpage X.

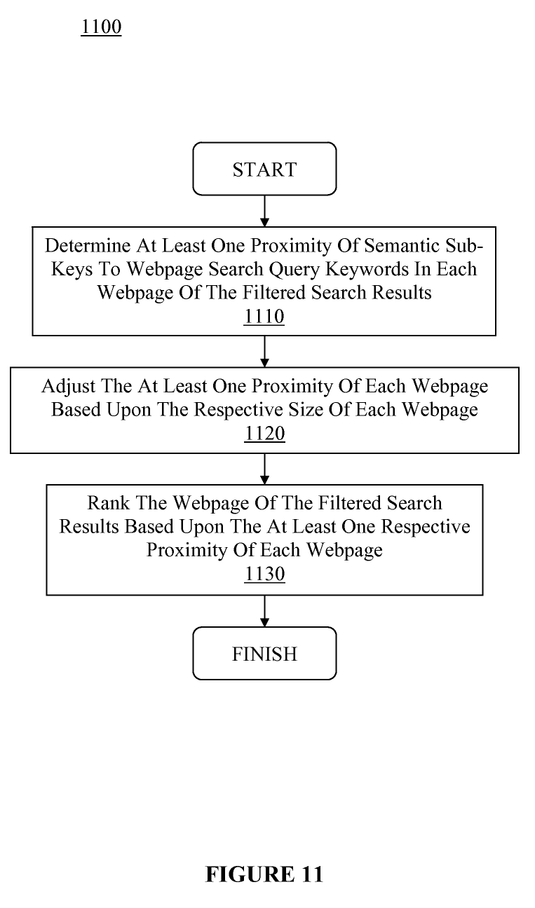

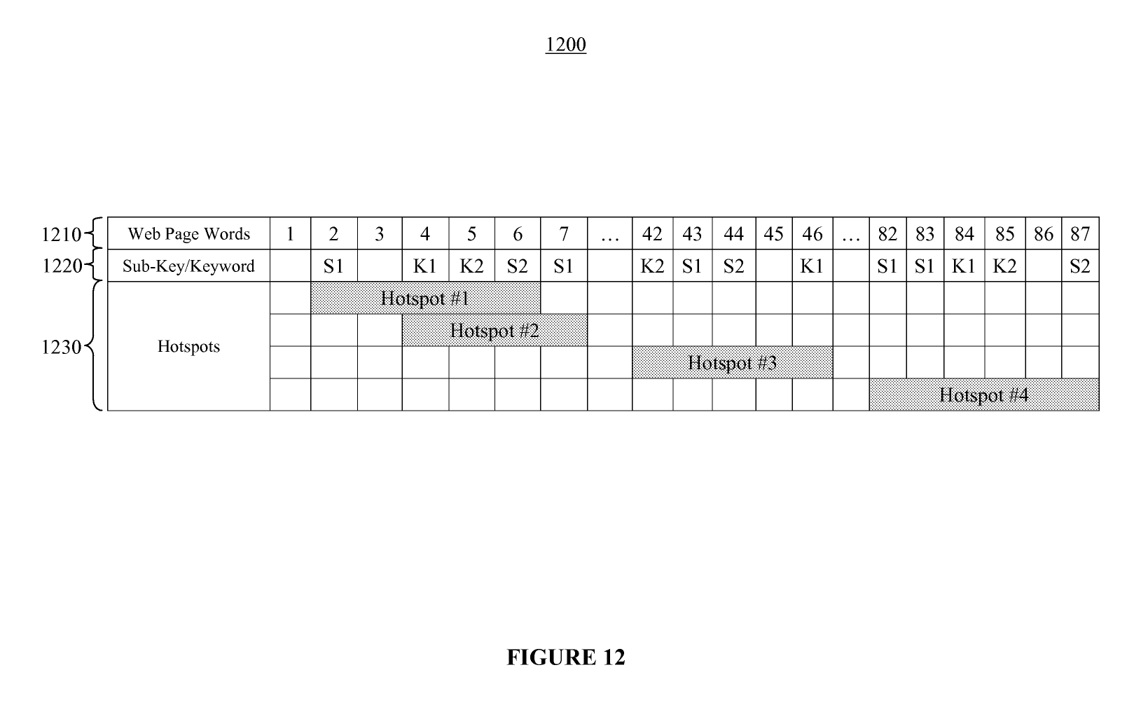

FIG. 11 shows an exemplary flow diagram of computer-implemented process 1100 for ranking webpage search results in accordance with a proximity of semantic sub-keys and search query keywords in accordance with one embodiment of the present invention. As shown in FIG. 11, step 1110 involves determining at least one proximity of semantic sub-keys (e.g., 345, 520, 620, etc.) to webpage search query keywords in each webpage of the filtered search results (e.g., 355). In one embodiment, the proximity may be determined by calculating the “distance” or other measure of proximity between two semantic sub-keys, between two keywords, between a semantic sub-key and a keyword, some combination thereof, etc. The measure of proximity may be determined based upon a sequential word ordering as discussed with respect to FIG. 12 in one embodiment.

FIG. 12 shows exemplary word sequential ordering 1200 of webpage content which may be used to determine proximity between two portions of the webpage in accordance with one embodiment of the present invention. As shown in FIG. 12, row 1210 comprises a sequential ordering of the words of the webpage, row 1220 comprises semantic sub-keys (e.g., S1 and S2) and keywords (e.g., K1 and K2) associated with one or more respective words of the webpage, and rows 1230 comprise four “hotspots” representing a collection of localized semantic sub-keys and/or keywords for which a proximity is determined. In one embodiment, a hotspot may comprise all of the semantic sub-keys (e.g., S1 and S2) and all of the keywords (e.g., K1 and K2) found in the webpage. In other embodiments, a hotspot may comprise less than all of the semantic sub-keys and/or keywords found in the webpage. Additionally, in one embodiment, multiple overlapping hotspots may be assigned a single proximity (e.g., equal to largest proximity of each individual overlapping hotspot, equal to smallest proximity of each individual overlapping hotspot, etc.).

The proximity for a given hotspot may be calculated by the number of word which the hotspot spans. For example, hotspot 1 may comprise a proximity of 5 (e.g., since it spans from word 2 to word 6), hotspot 2 may comprise a proximity of 4 (e.g., since it spans from word 4 to word 7), hotspot 3 may comprise a proximity of 5 (e.g., since it spans from word 42 to word 46), and hotspot 4 may comprise a proximity of 6 (e.g., since it spans from word 82 to word 87). In one embodiment, a single proximity (e.g., the highest proximity, the lowest proximity, an average proximity, etc.) may be assigned to each webpage in step 1110.

As shown in FIG. 11, step 1120 involves adjusting the at least one proximity of each webpage based upon the respective size of each webpage. For example, the proximity for each webpage of the search results may be scaled (e.g., divided) by a factor associated with its respective webpage size (e.g., number of words, number of lines, frame size, etc.) in one embodiment. Additionally, in one embodiment, a single proximity (e.g., the highest scaled proximity, the lowest scaled proximity, an average scaled proximity, etc.) may be assigned to each webpage in step 1120 (e.g., if a single proximity was not selected for each webpage in step 1110).

Step 1130 involves ranking the webpages of the filtered search results based upon the at least one respective proximity of each webpage. For example, if webpage X has a proximity (e.g., non-scaled as determined in step 1110 and/or scaled as determined in step 1120) of 6, while webpage Y has a proximity of 4, then webpage Y may be ranked ahead of webpage X in one embodiment. In this case, a lower proximity of webpage Y may indicate that webpage Y is more relevant to the search query (e.g., 310) than webpage X in one embodiment, hence the higher ranking of webpage Y with respect to webpage X.

Turning back to FIG. 2, step 280 involves outputting the webpage search results. The search results output in step 280 may comprise filtered search results (e.g., accessed from filtering component 350 without ranking as depicted by arrow 352 of FIG. 3) or ranked search results (e.g., accessed from ranking component 360). Additionally, in one embodiment, the outputting performed in step 280 may comprise outputting graphical data (e.g., search result output for presentation 275 generated by graphical data generator 370) based upon the search results (e.g., 355 or 365). For example, the search results may be transformed (e.g., by graphical data generator 370) into a format (e.g., C, C++, Java, HTML, etc.) operable to be displayed by a computer system application (e.g., a web browser, etc.), where the displayed information may comprise a graphical user interface (e.g., 125a, 125b, 1300, etc.) in one embodiment.

As shown in FIG. 3, the search result output (e.g., 375) may be configured or controlled by input 377, where input 377 may comprise a user input, system-generated input, etc. In one embodiment, information associated with one or more webpages of the search results (e.g., 355, 365, etc.) may be hidden or not displayed in response to input 377. For example, input 377 may comprise a selection of at least one semantic key and/or at least one semantic sub-key, where information associated with a selected semantic key and/or semantic sub-key may be included in output 372 for display, while information associated with a non-selected semantic key and/or semantic sub-key may be excluded from output 372 (e.g., for effectively hiding or not displaying that information).

FIG. 13 shows exemplary on-screen graphical user interface (GUI) 1300 for performing webpage searches in accordance with one embodiment of the present invention. As shown in FIG. 13, GUI 1300 may comprise region 1310 for entering search queries. For example, a user may enter the following search query (e.g., 310) as depicted in FIG. 13: “How tall is the Eiffel Tower?” The search query may comprise a question. Alternatively, the search query may comprise a series of keywords and/or phrases. Additionally, in one embodiment, the search query (e.g., 310) entered into region 1310 may comprise at least one operator (e.g., “and,” “or,” etc.) and/or other data for controlling the search performed by the search engine (e.g., 320).

GUI 1300 may also comprise graphical object 1320 for initiating a webpage search based upon the search query (e.g., 310) entered into region 1310. In response to interaction (e.g., moving a mouse pointer or cursor over graphical object 1320 and clicking a button on the mouse) with graphical object 1320, the webpage search may be conducted and results of the search may be displayed in other regions of GUI 1300 (e.g., as depicted in FIG. 14).

FIG. 14 shows exemplary on-screen GUI 1300 for performing webpage searches with search results displayed in accordance with one embodiment of the present invention. As shown in FIG. 14, region 1330 may display a portion of search result output 375 comprising one or more answers (e.g., 1332 and 1334) to a question entered in region 1310. The answer may comprise a first portion which comprises a numerical value (e.g., 324, 1063, etc.) extracted from one or more of the webpages of the search results (e.g., 355, 365, etc.). Additionally, the answer may comprise a second portion (e.g., the units “meters” and “feet”) which may correspond to the first portion. The second portion may also be associated with a semantic sub-key (e.g., 345, 520, 620, etc.). Further, in one embodiment, the first portion may be derived from a webpage of the search results (e.g., 355, 365, etc.) associated with the semantic sub-key (e.g., which is also associated with the second portion).

In one embodiment, where the focus (e.g., 335) of a search query (e.g., 310) relates to a number (e.g., relating to distance, height, etc.), then it may be determined that the answer (e.g., displayed in region 1330) may comprise a number (e.g., forming the first portion of the answer). As such, one or more numbers (e.g., 324, 1063, etc.) may be extracted from the search results (e.g., 355, 365, etc.) and paired with an appropriate modifier (e.g., related to a semantic sub-key used to filter and/or generate the search results). The number may be located in close proximity to the modifier or the semantic sub-key corresponding thereto (e.g., determined by a sequential word ordering as discussed with respect to FIG. 12). For example, if the number “1063” is commonly found in the search results (e.g., related to the Eiffel Tower) within a few words of the word “feet,” then the number “1063” may be selected to be paired with the modifier “feet” for display in region 1330. Additionally, where multiple numbers are found in the search results near a modifier or a semantic sub-key corresponding thereto, then the more frequently occurring number may be selected to be paired with the modifier and displayed in region 1330.

As a further example, the search query (e.g., 310) entered in region 1310 may comprise the following question: “Which countries border the United States?” The focus (e.g., 335) of the search query (e.g., 310) may be determined to be the word “country,” and thus, the semantic sub-keys (e.g., 345, 520, 620, etc.) for the search may comprise a list of countries (e.g., as depicted in FIG. 5). In one embodiment, the semantic sub-keys (e.g., 345, 520, 620, etc.) associated with the webpages from the search results (e.g., 355, 365, etc.) with the highest rankings may be selected for display within region 1330 of GUI 1300. For example, a large majority of the highest ranked webpages may comprise the semantic sub-keys “Canada” and “Mexico,” and thus, the words “Canada” and “Mexico” may be selected as answers to the question presented in the search query (e.g., 310) and consequently be displayed in region 1330.

Each of the answers displayed in region 1330 may be hyperlinked in one embodiment. As such, upon interacting with one of the answers displayed in region 1330, one or more webpages related to an activated answer may be displayed (e.g., to provide additional information related to the search query and/or the specific answer which was interacted with). Further, in one embodiment, the webpages brought up in response to interaction with an answer displayed in region 1330 may comprise at least one highlighted semantic sub-key and/or at least one highlighted keyword. As such, embodiments enable relevant information in the webpages to be more quickly located.

As shown in FIG. 13, region 1340 may comprise a listing of webpages (e.g., 1342-1346) generated from search result output 375. The webpages may comprise filtered search results (e.g., 355) and/or ranked search results (e.g., 365). In this manner, the listing of webpages in region 1340 may be ordered in accordance with the ranked search results (e.g., 365 output by ranking component 360). Additionally, one or more of the webpages may be hyperlinked in one embodiment. As such, upon interacting with one of the webpages displayed in region 1340, one or more additional webpages (e.g., related to the activated webpage listed in region 1340) may be displayed (e.g., to provide additional information related to the search query and/or the webpage which was interacted with).

Region 1340 may also comprise additional information 1343-1347, each related to a respective webpage listed in region 1340. Additional information 1343-1347 may comprise one or more words, phrases, passages, etc. of each respective webpage. Additionally, additional information 1343-1347 may comprise at least one highlighted semantic sub-key and/or at least one highlighted keyword. As such, embodiments enable relevant information in the webpages (e.g., listed in region 1340) to be more quickly located.

As shown in FIG. 14, GUI 1300 may also comprise region 1350 for displaying semantic keys and/or semantic sub-keys (e.g., used to generate search results displayed in region 1330 and/or region 1340). In one embodiment, at least one interactive graphical object (e.g., 1351-1355) may be displayed in region 1350, where each interactive graphical object may correspond to a semantic key and/or a semantic sub-key. The interactive graphical objects (e.g., 1351-1355) may be used to select or de-select a semantic key and/or a semantic sub-key. In one embodiment, selection of a semantic key and/or semantic sub-key may cause search results associated with the selected semantic key and/or semantic sub-key to be displayed in region 1330 and/or region 1340. Additionally, de-selection of a semantic key and/or semantic sub-key may cause search results associated with the selected semantic key and/or semantic sub-key to be hidden or not displayed (e.g., in region 1330 and/or region 1340). In this manner, in one embodiment, selection of interactive graphical object 1354 (e.g., associated with the semantic sub-key labeled “feet”) and interactive graphical object 1355 (e.g., associated with the semantic sub-key labeled “meters”) may cause the answers related to the respective semantic sub-keys to be displayed in region 1330. Additionally, selection of interactive graphical object 1354 and interactive graphical object 1355 may cause one or more webpages related to the related to the respective semantic sub-keys to be displayed in region 1340.

Interactive graphical objects (e.g., 1351-1355) displayed in region 1350 of GUI 1300 may be used to input or otherwise communicate input 377 (e.g., to a graphical data generator). In this manner, the interactive graphical objects may be used to alter the display of the search results (e.g., 375) without initiating a new webpage search in one embodiment.

Alternatively, the interactive graphical objects may also be used to initiate a new webpage search in one embodiment. For example, de-selection of a graphical object associated with a given semantic sub-key may cause the output of semantic sub-keys 345 (e.g., by semantic key processor 340) without the given semantic sub-key, which may in turn cause the semantic sub-key search results (e.g., 324) to be output (e.g., by search engine 320) without search results associated with the given semantic sub-key, and which in turn may affect the search results accessed and/or output by other components (e.g., filtering component 350, ranking component 360, graphical data generator 370, etc.). Accordingly, altering the active semantic sub-keys (e.g., by selecting or deselecting at least one semantic sub-key) displayed in region 1350 may alter the display of search results (e.g., 375) by generating a new webpage search (e.g., performed by search engine 320).

Interaction with an interactive graphical object associated with a superior or parent node may select or de-select all child nodes in one embodiment. For example, interaction with interactive graphical object 1351 may select or de-select all other semantic sub-keys displayed below interactive graphical object 1351 (e.g., 1352-1355). Additionally, interaction with interactive graphical object 1352 may select or de-select all other semantic sub-keys displayed below interactive graphical object 1352 and above interactive graphical object 1353 (e.g., 1354).

GUI 1300 may also comprise graphical object 1360 for updating the display of search results (e.g., 375) displayed in region 1330 and/or 1340. For example, in response to activating or deactivating a semantic sub-key displayed in region 1350, interaction with graphical object 1360 may update the display of search results (e.g., 375) displayed in region 1330 and/or 1340 without initiating a new webpage search (e.g., communicating input 377 with the new semantic sub-key configuration for altering search result output 375) in one embodiment. Alternatively, in response to activating or deactivating a semantic sub-key displayed in region 1350, interaction with graphical object 1360 may update the display of search results (e.g., 375) displayed in region 1330 and/or 1340 by initiating a new webpage search (e.g., based upon the new semantic sub-key configuration indicated by interactive graphical objects 1351-1355 of region 1350) in one embodiment. Further, it should be appreciated that the display of search results in GUI 1300 may be updated (e.g., with or without initiation of a new search) automatically (e.g., without interaction with graphical object 1360) in response to interaction with one or more interactive graphical objects (e.g., 1351-1355) displayed in region 1350 of GUI 1300.

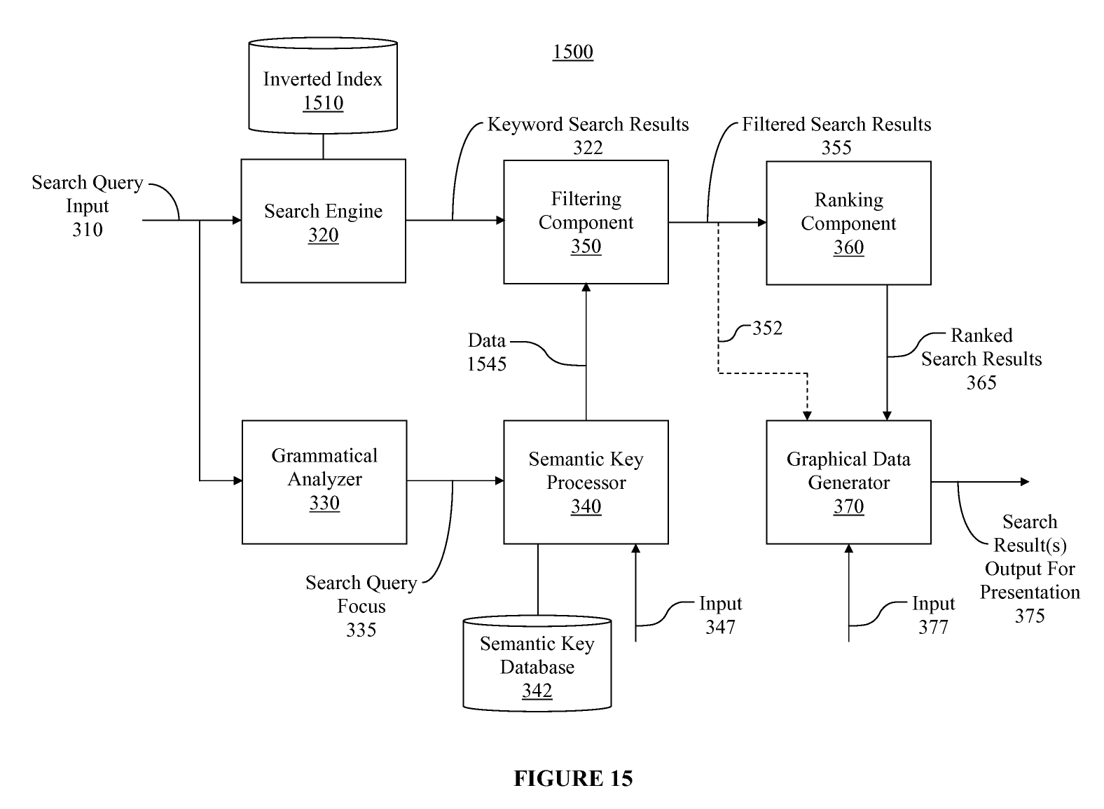

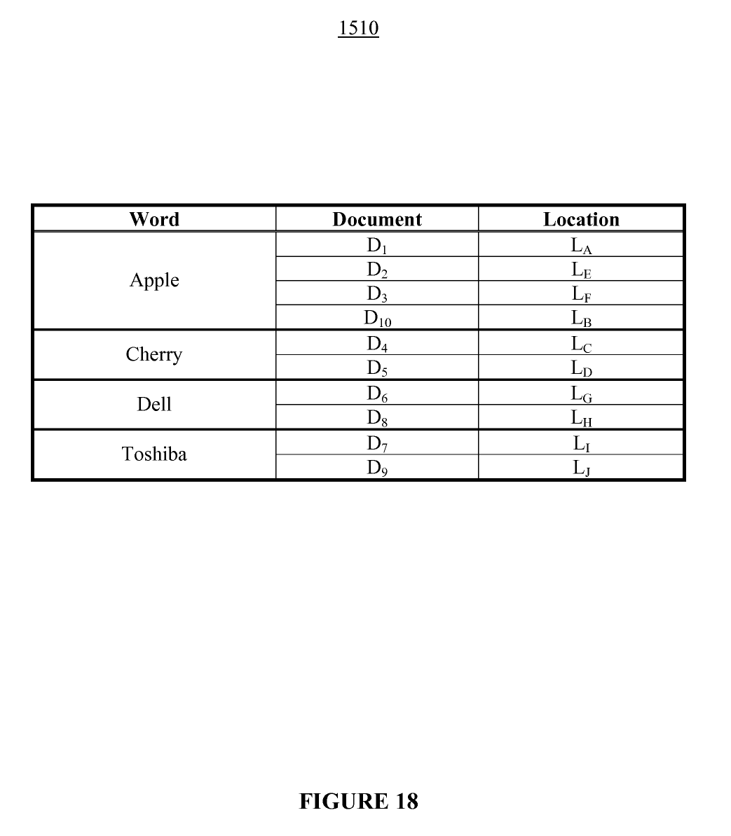

FIG. 15 shows exemplary data flow diagram 1500 of the performance of a search in accordance with one embodiment of the present invention. As shown in FIG. 15, a search may be performed by search engine 320 based on search query input 310. Search engine 320 may perform the search by indexing inverted index 1510 (e.g., using the search query input 310) to generate keyword search results 322. Inverted index 1510 may be a data structure including a plurality of words (e.g., semantic keys or a portion thereof, semantic sub-keys or a portion thereof, words which are not semantic keys, words which are not semantic sub-keys, etc.) and at least one respective document (or document identifier) corresponding to each word (e.g., as shown in FIG. 18).

Grammatical analyzer 330 may generate search query focus 335 based on search query input (e.g., as described above with respect to FIG. 2, FIG. 3, etc.). Semantic key processor 340 may output data 1545 (e.g., at least one document identifier, at least one complete document, at least one portion of at least one document, other information associated with at least one document, some combination thereof, etc.) based on search query focus 335 and/or input 347. For example, semantic key processor 340 may determine a semantic key associated with search query focus 335, where the semantic key may be used to index semantic key database 342 to return data 1545 associated with the semantic key and/or at least one semantic sub-key associated with the semantic key.

Filtering component 350 may use data 1545 to filter keyword search results 322 and generate filtered keyword search results 355. For example, search results may be removed from keyword search results 322 which are not associated with data 1545. As another example, search results may be removed from keyword search results 322 which do not include at least a portion of data 1545. And as a further example, search results may be removed from keyword search results 322 which do not include the semantic key (e.g., associated with search query focus 335) and/or at least one semantic sub-key associated with the semantic key.

The filtered search results may then be ranked by ranking component 360 to generate ranked search results 365 (e.g., as discussed above with respect to FIG. 2, FIG. 3, FIG. 7A, FIG. 7B, FIG. 8A, FIG. 8B, etc.). The ranking may be performed using data 1545 in one embodiment. And in one embodiment, the ranking may be performed using the semantic key (e.g., associated with search query focus 335) and/or at least one semantic sub-key associated with the semantic key.

Graphical data generator 370 may output at least one search result (e.g., 375) for presentation (e.g., as discussed above with respect to FIG. 2, FIG. 3, etc.). Graphical data generator may generate graphical data based on ranked search results (e.g., 365 output by ranking component 360) and/or filtered search results (e.g., 355 output by filtering component 350 as indicated by dashed arrow 352). And in one embodiment, the at least one search result may be output for presentation (e.g., 375) based on input 377.

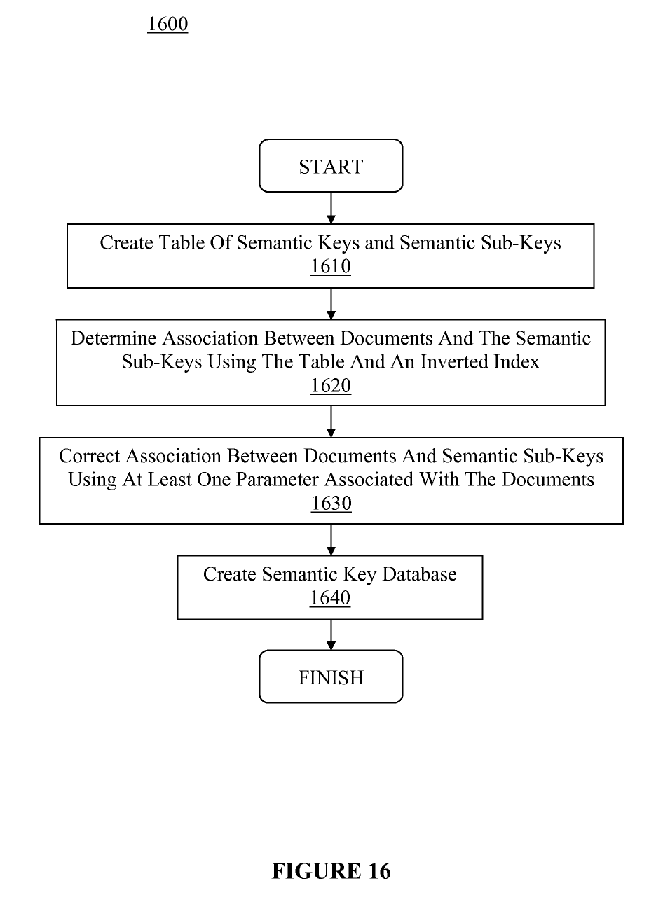

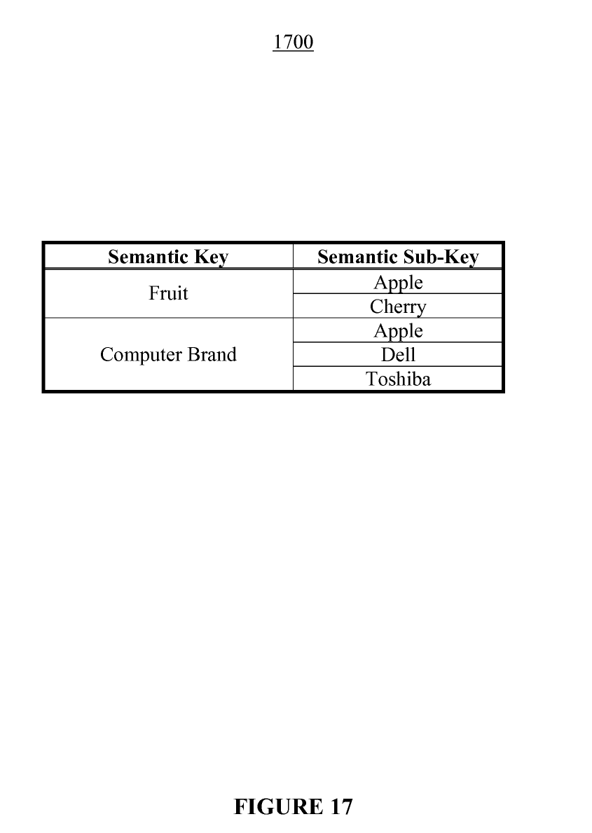

FIG. 16 shows an exemplary flow diagram of computer-implemented process 1600 for creating a semantic key database (e.g., 342) in accordance with one embodiment of the present invention. As shown in FIG. 16, step 1610 involves creating a table of semantic keys and semantic sub-keys. For example, as shown in FIG. 17, table 1700 may include at least one semantic key (e.g., “fruit,” “computer brand,” at least one other semantic key, etc.) and at least one respective semantic sub-key corresponding to each semantic key (e.g., “apple” and “cherry” corresponding to the semantic key “fruit,” “Apple,” “Dell” and “Toshiba” corresponding to the semantic key “computer brand,” at least one other semantic sub-key, etc.).

Step 1620 may involve determining the association between documents (e.g., at least one webpage, at least one electronic document or file, advertising content, etc.) and the semantic sub-keys using the table (e.g., created and/or accessed in step 1610, 1700, etc.) and an inverted index (e.g., 1510). In one embodiment, as shown in FIG. 18, inverted index 1510 may include a plurality of words (e.g., “apple,” “cherry,” “Dell,” “Toshiba,” etc.) which are each located at a respective location (e.g., shown in the rightmost column of index 1510) with a respective document (e.g., shown in the middle column of index 1510). The words of index 1510 may or may not be semantic keys, semantic sub-keys, etc. As such, step 1620 may involve determining or accessing (e.g., from index 1510) at least one respective document (e.g., D₁, D₂, D₃ and D₁₀) and/or at least one respective document location (e.g., L_{A}, L_{E}, L_{F} and L_{B}) that is associated with each semantic sub-key (e.g., “apple”) and/or semantic key (e.g., “fruit,” “computer brand,” etc.) found in the table (e.g., table 1700).

As shown in FIG. 16, step 1630 involves correcting the association between the documents (and/or document locations) and the semantic sub-keys using at least one parameter associated with the documents. For example, where a semantic sub-key (e.g., “apple”) is associated with more than one semantic key (e.g., “fruit” and “computer brand”) based on the data of index 1510, step 1630 may involve determining which semantic key each document and document location is associated with using at least one parameter associated with the document.

In one embodiment, the parameter may be a relationship (e.g., syntactic relationship such as subject-verb, verb-object, in the same sentence, in the same clause, in the same phrase, etc.) between a semantic sub-key and at least one word or phrase of the document. For example, where a document (e.g., D₁) includes the semantic sub-key “apple” used in the sentence “the apple tastes good,” the word “tastes” (e.g., in a subject-verb relationship with the semantic sub-key “apple”) may be used to determine in step 1630 that the semantic sub-key “apple” (and therefore the document D₁ and/or the location in the document L_{A}) is associated with the semantic key “fruit” and not the semantic key “computer brand” (e.g., as shown in semantic key database 342 in FIG. 19).

In one embodiment, the parameter may be a proximity or distance (e.g., a number of words, number of lines, number of paragraphs, etc.) between a semantic sub-key and at least one word or phrase of the document. For example, if the semantic sub-key (e.g., “apple”) and the word (e.g., “tastes” in the above example) are within a predetermined proximity or distance (e.g., a predetermined number of words, predetermined number of lines, predetermined number of paragraphs, etc.), then it may be determined in step 1630 that the semantic sub-key “apple” (and therefore the document D₁ and/or the location in the document L_{A}) is associated with the semantic key “fruit” (e.g., as shown in semantic key database 342 in FIG. 19).

In one embodiment, the parameter may be a quantity of words (e.g., a number of instances of a word) associated with a semantic sub-key in the document. For example, if a quantity of words (e.g., a number of instances of the word “tastes” in the above example) meets or exceeds a predetermined threshold, then it may be determined in step 1630 that the semantic sub-key “apple” (and therefore the document D₁ and/or the location in the document L_{A}) is associated with the semantic key “fruit” (e.g., as shown in semantic key database 342 in FIG. 19).

In one embodiment, the parameter may be a theme found in the document. In one embodiment, the theme (e.g., a major theme, complementary theme, minor theme, etc.) may be determined in accordance with U.S. patent application Ser. No. 12/884,395, filed on Sep. 17, 2010, entitled “Method and System for Scoring Texts,” which is incorporated herein by reference in its entirety and for all purposes. For example, where a theme of a document (e.g., D₂) is determined to be “computer programming” or the like, it may be determined in step 1630 that that the semantic sub-key “apple” (and therefore the document D₂ and/or the location in the document L_{E}) is associated with the semantic key “computer brand” (e.g., as shown in semantic key database 342 in FIG. 19).

As shown in FIG. 16, step 1640 involves creating a semantic key database (e.g., 342 as shown in FIG. 19). The semantic key database may be created using information from the table (e.g., created in step 1610) and the association between the documents and the semantic sub-keys (e.g., determined in step 1620, corrected and/or further determined in step 1630, etc.) in one embodiment.

Although FIG. 15 shows data flow diagram 1500 with a specific number of components, it should be appreciated that data flow diagram 1500 may include a different number of components in other embodiments. Although FIG. 15 shows data flow diagram 1500 with a specific arrangement of components, it should be appreciated that data flow diagram 1500 may include a different arrangement of components in other embodiments.

Although FIG. 16 shows process 1600 with a specific number of steps, it should be appreciated that process 1600 may have a different number of steps in other embodiments. Although FIG. 16 shows process 1600 with a specific ordering of steps, it should be appreciated that process 1600 may have a different ordering of steps in other embodiments.

Although FIG. 17 depicts table 1700 with a certain amount or type of data, it should be appreciated that table 1700 may have a different amount or type of data in other embodiments. Additionally, although FIG. 17 depicts table 1700 with a certain arrangement of data, it should be appreciated that table 1700 may have a different arrangement of data in other embodiments.

Although FIG. 18 depicts inverted index 1510 with a certain amount or type of data, it should be appreciated that inverted index 1510 may have a different amount or type of data in other embodiments. Additionally, although FIG. 18 depicts inverted index 1510 with a certain arrangement of data, it should be appreciated that inverted index 1510 may have a different arrangement of data in other embodiments.

Although FIG. 19 depicts semantic key database 342 with a certain amount or type of data, it should be appreciated that semantic key database 342 may have a different amount or type of data in other embodiments. Additionally, although FIG. 19 depicts semantic key database 342 with a certain arrangement of data, it should be appreciated that semantic key database 342 may have a different arrangement of data in other embodiments.

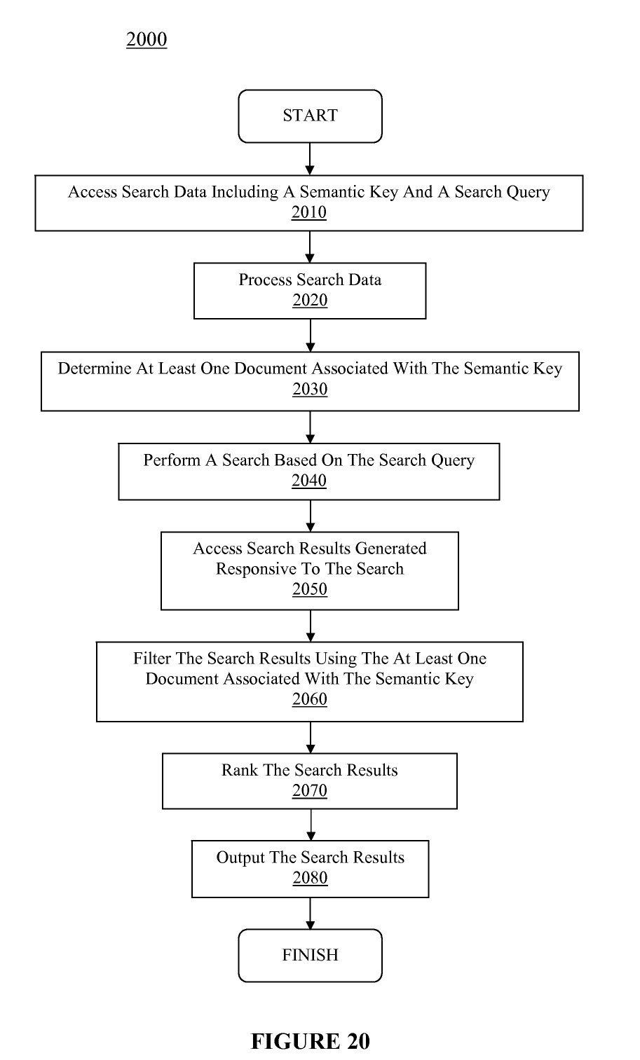

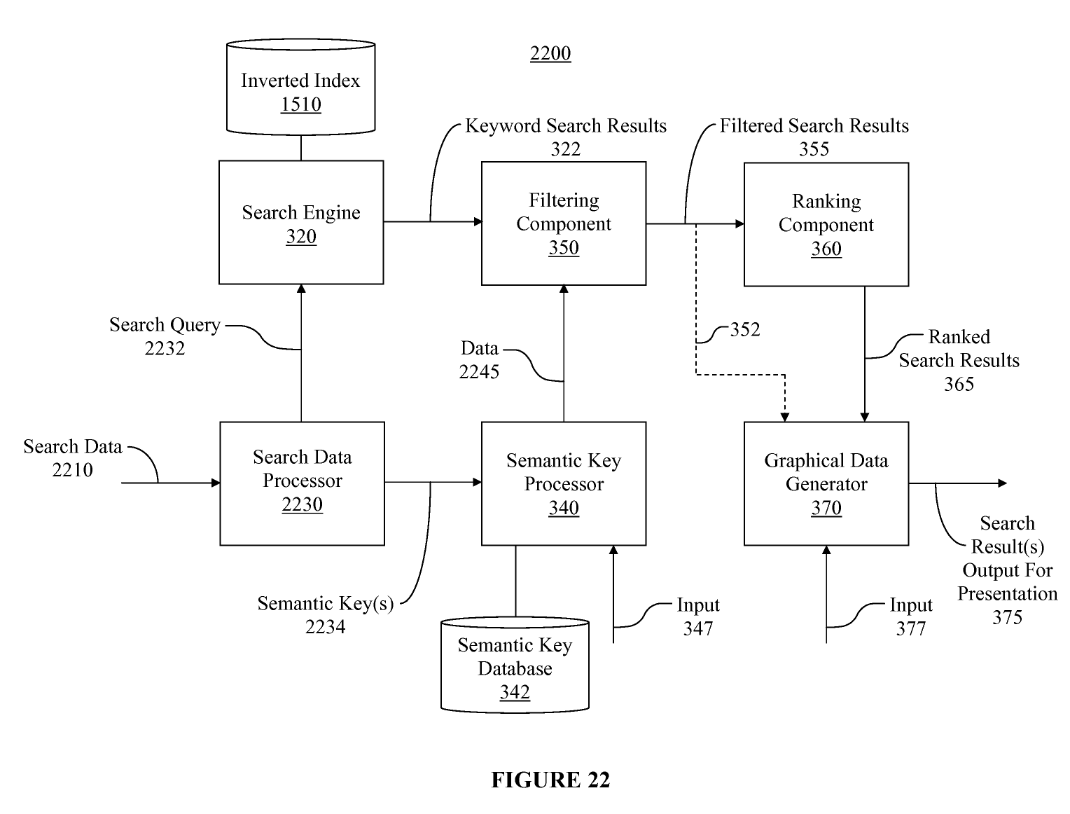

FIG. 20 shows an exemplary flow diagram of computer-implemented process 2000 for performing a search in accordance with one embodiment of the present invention. As the steps of process 2000 are described herein, reference will be made to exemplary data flow diagram 2200 of FIG. 22 to provide examples and help clarify the discussion.

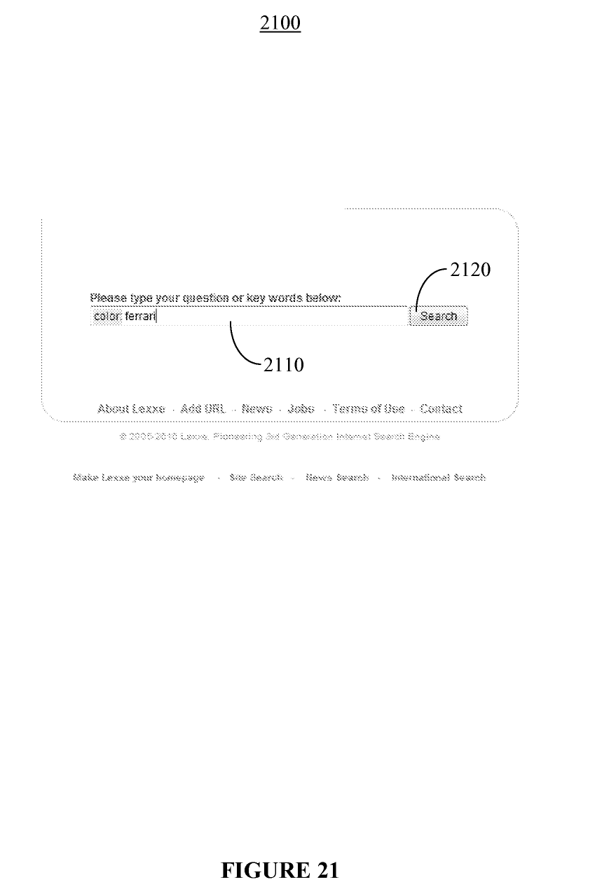

As shown in FIG. 20, step 2010 involves accessing search data (e.g., 2210) including a semantic key and a search query. The search data may be input by a user via a user interface. For example, a user may enter search data in region 2110 (e.g., including a form field such as a text entry box, drop-down list box, etc.) of on-screen graphical user interface 2100 of FIG. 21, where the search data includes a semantic key (e.g., the word “color”) and a search query (e.g., the word “Ferrari”). It should be appreciated that the semantic key may include any number of words or characters, and it should also be appreciated that the search query may include any number of words or characters. The semantic key and search query may be separated by at least one symbol (e.g., a colon, hyphen, operator, etc.) in one embodiment. And in one embodiment, the search data may be accessed in step 2010 by search data processor 2230.

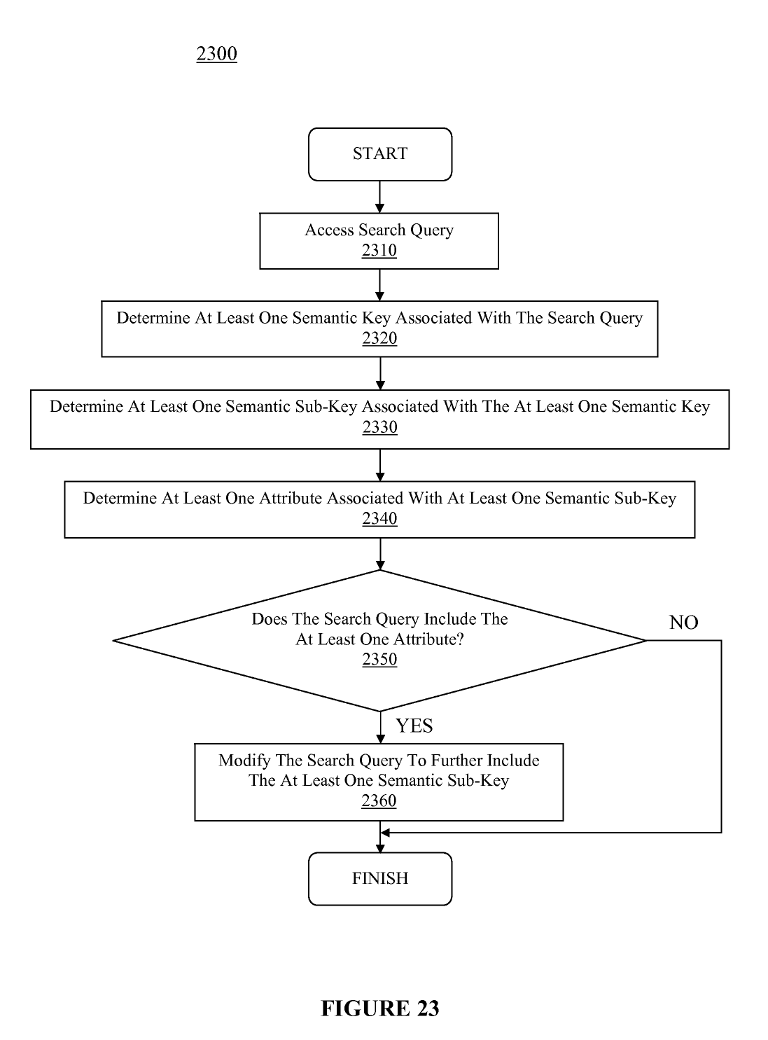

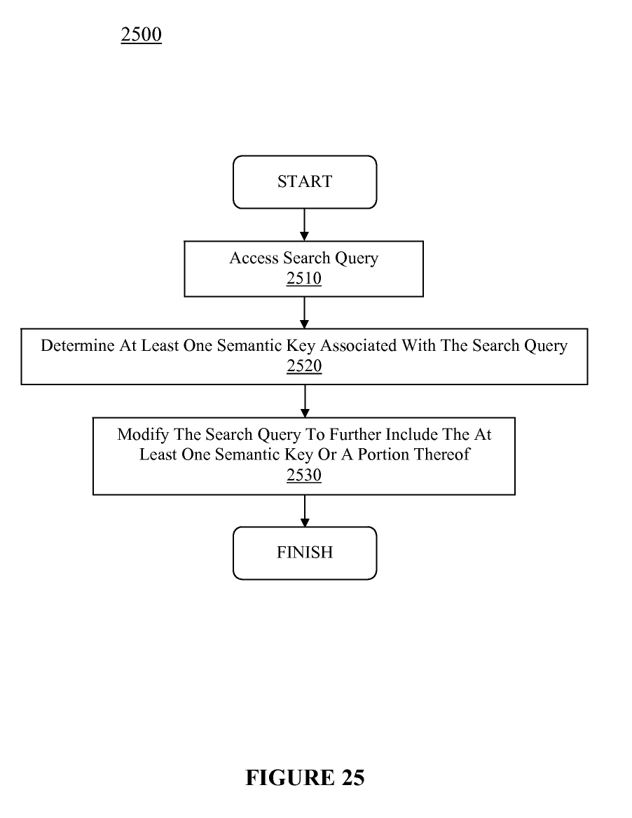

Step 2020 involves processing the search data (e.g., using search data processor 2230). In one embodiment, the processing in step 2020 may involve splitting the semantic key (e.g., 2234) and the search query (e.g., 2232), extracting the semantic key (e.g., 2234) from the search data, extracting the search query (e.g., 2232) from the search data, etc. In one embodiment, the processing in step 2020 may involve modifying the search query (e.g., 2232) to further include at least one semantic sub-key associated with the semantic key (e.g., 2234) (e.g., in accordance with process 2300 of FIG. 23). And in one embodiment, the processing in step 2020 may involve modifying the search query (e.g., 2232) to further include the semantic key (e.g., 2234) or a portion thereof (e.g., in accordance with process 2500 of FIG. 25).

FIG. 23 shows an exemplary flow diagram of computer-implemented process 2300 for modifying a search query to further include at least one semantic sub-key in accordance with one embodiment of the present invention. As shown in FIG. 23, step 2310 involves accessing a search query (e.g., 2232 from search data 2210, search query input 310, etc.). In one embodiment, where the search query is accessed from search data (e.g., 2210), the search query (e.g., 2232) may be extracted from the search data or otherwise generated by a search data processor (e.g., 2230).

Step 2320 involves determining at least one semantic key associated with the search query (e.g., accessed in step 2310). In one embodiment, the at least one semantic key may be determined (e.g., using search data processor 2230) from search data (e.g., 2210) in step 2320. In one embodiment, the at least one semantic key may be determined (e.g., using grammatical analyzer 330 and/or semantic key processor 340) in step 2320 based on a focus of a search query (e.g., 335), where the search query focus (e.g., 335) may be used to index a semantic key database (e.g., 342) to access the at least one semantic key.

As shown in FIG. 23, step 2330 involves determining at least one semantic sub-key associated with the at least one semantic key (e.g., determined in step 2320). In one embodiment, the at least one semantic sub-key may be determined (e.g., using semantic key processor 340) by indexing a semantic key database (e.g., 342) using the semantic key to access the at least one semantic sub-key.

Step 2340 involves determining at least one attribute associated with at least one semantic sub-key (e.g., determined in step 2330). In one embodiment, the at least one attribute may be determined (e.g., using semantic key processor 340) by indexing a semantic key database (e.g., 342) using the semantic sub-key to access the at least one attribute. For example, where the semantic key (e.g., determined in step 2320) includes the words “United States State Flower” and the semantic sub-key (e.g., determined in step 2330) includes the word “rose,” semantic key database 342 may be indexed in step 2340 using the semantic sub-key “rose” to determine the attribute “New York” (e.g., as shown in semantic key database 342 of FIG. 24).

As shown in FIG. 23, step 2350 involves determining whether the search query (e.g., accessed in step 2310) includes the at least one attribute (e.g., determined in step 2340). If it is determined in step 2350 that the search query does not include the at least one attribute, then process 2300 may conclude. Alternatively, if it is determined in step 2350 that the search query includes the at least one attribute, then step 2360 may be performed.

Step 2360 involves modifying the search query (e.g., accessed in step 2310) to further include the at least one semantic sub-key (e.g., determined in step 2330). For example, where the search query is determined to include the at least one attribute “New York,” the search query may be modified in step 2360 to further include the semantic sub-key “rose.” In one embodiment, modification of the search query may be transparent to and/or hidden from a user (e.g., not displayed in a graphical user interface such as user interface 2100, another graphical user interface used to perform or initiate a search, etc.). In this manner, embodiments of the present invention may enable more relevant search results to be returned (e.g., as a result of the search preformed in step 2040 of process 2000) by modifying a search query to include at least one semantic sub-key (e.g., associated with a semantic key such as semantic key 2234, determined based on search query focus 335, etc.) if the search query includes at least one attribute (e.g., associated with the semantic sub-key).

Although FIG. 23 shows process 2300 with a specific number of steps, it should be appreciated that process 2300 may have a different number of steps in other embodiments. Although FIG. 23 shows process 2300 with a specific ordering of steps, it should be appreciated that process 2300 may have a different ordering of steps in other embodiments.

Although FIG. 24 depicts semantic key database 342 with a certain amount or type of data, it should be appreciated that semantic key database 342 may have a different amount or type of data in other embodiments. Additionally, although FIG. 24 depicts semantic key database 342 with a certain arrangement of data, it should be appreciated that semantic key database 342 may have a different arrangement of data in other embodiments.

FIG. 25 shows an exemplary flow diagram of computer-implemented process 2500 for modifying a search query to further include a semantic key or a portion thereof in accordance with one embodiment of the present invention. As shown in FIG. 25, step 2510 involves accessing a search query (e.g., 2232 from search data 2210, search query input 310, etc.). In one embodiment, where the search query is accessed from search data (e.g., 2210), the search query (e.g., 2232) may be extracted from the search data or otherwise generated by a search data processor (e.g., 2230).

Step 2520 involves determining at least one semantic key associated with the search query (e.g., accessed in step 2510). In one embodiment, the at least one semantic key may be determined (e.g., using search data processor 2230) from search data (e.g., 2210) in step 2520. In one embodiment, the at least one semantic key may be determined (e.g., using grammatical analyzer 330 and/or semantic key processor 340) in step 2520 based on a focus of a search query (e.g., 335), where the search query focus (e.g., 335) may be used to index a semantic key database (e.g., 342) to access the at least one semantic key.

As shown in FIG. 25, step 2530 involves modifying the search query (e.g., accessed in step 2510) to further include the at least one semantic key (e.g., determined in step 2520) or a portion thereof. For example, where the search query includes the word “2008” (as accessed in step 2510) and the semantic key associated with the search query is determined to be “Nobel laureate chemistry” (e.g., in step 2520), the search query may be modified in step 2530 to further include the words “nobel” (e.g., a portion of the semantic key “Nobel laureate chemistry”). As another example, where the search query includes the word “2008” (as accessed in step 2510) and the semantic key associated with the search query is determined to be “Nobel laureate chemistry” (e.g., in step 2520), the search query may be modified in step 2530 to further include the words “Nobel laureate chemistry” (e.g., the entire semantic key “Nobel laureate chemistry”). In this manner, embodiments of the present invention may enable more relevant search results to be returned (e.g., as a result of the search preformed in step 2040 of process 2000) by modifying a search query to include at least one semantic key (e.g., determined based on one or more words of the search query) or a portion thereof.

Although FIG. 25 shows process 2500 with a specific number of steps, it should be appreciated that process 2500 may have a different number of steps in other embodiments. Although FIG. 25 shows process 2500 with a specific ordering of steps, it should be appreciated that process 2500 may have a different ordering of steps in other embodiments.

Turning back to FIG. 20, step 2030 involves determining at least one document (e.g., a webpage, electronic document or file, advertising content, etc.) associated with the semantic key (e.g., accessed in step 2010 and/or step 2020). The at least one document may be determined in step 2030 by indexing semantic key database 342 using the semantic key to access or otherwise determine one or more documents associated with the semantic key and/or a semantic sub-key associated with the semantic key. For example, semantic key database 342 may be indexed using the semantic key “fruit” to access or otherwise determine one or more documents (e.g., D₁, D₁₀, D₄, D₅, etc. as shown in FIG. 19) associated with the semantic key. As another example, semantic key database 342 may be indexed using a semantic sub-key (e.g., “apple”) associated with the semantic key (e.g., “fruit”) to access or otherwise determine one or more documents (e.g., D₁, D₁₀, etc. as shown in FIG. 19) associated with the semantic sub-key and/or semantic key. In one embodiment, step 2030 may involve generating and/or outputting data (e.g., 2245) which includes at least one document identifier, at least one complete document, at least one portion of at least one document, other information associated with at least one document, some combination thereof, etc.

Step 2040 involves performing a search based on the search query (e.g., 2232, accessed in step 2010 and/or step 2020, etc.). The search may be a keyword search (e.g., based upon one or more words or keywords of the search query). Search engine 320 may perform the search in step 2040 based on search query 2232 and generate keyword search results 322 based thereon (e.g., by indexing inverted index 1510 using search query 2232 to access and/or generate keyword search results 322). The search results (e.g., 322) may include at least one webpage, at least one electronic document or file, advertising content, some combination thereof, etc.

As shown in FIG. 20, step 2050 involves accessing search results (e.g., 322) generated responsive to the search (e.g., performed in step 2040). The search results may be accessed by a component capable of filtering the search results (e.g., filtering component 350 shown in FIG. 22), a component capable of ranking the search results (e.g., ranking component 360 as shown in FIG. 22), some combination thereof, etc.

Step 2060 involves filtering the search results (e.g., accessed in step 2050) using the at least one document associated with the semantic key (e.g., determined in step 2030). For example, filtering component 350 may use data 2245 (e.g., including at least one document identifier of at least one document associated with the semantic key, at least one complete document associated with the semantic key, at least one portion of at least one document associated with the semantic key, other information associated with at least one document associated with the semantic key, some combination thereof, etc.) to filter keyword search results 322 and generate filtered keyword search results 355.

In one embodiment, filtering may be performed in step 2060 by removing search results from keyword search results 322 which are not associated with data 2245. As another example, filtering may be performed in step 2060 by removing search results from keyword search results 322 which do not include at least a portion of data 2245. And as a further example, filtering may be performed in step 2060 by removing search results from keyword search results 322 which do not include the semantic key (e.g., 2232, determined in step 2010 and/or step 2020, etc.) and/or at least one semantic sub-key associated with the semantic key.

As shown in FIG. 20, step 2070 involves ranking the search results (e.g., the search results accessed in step 2050, the filtered search results generated in step 2060, etc.). For example, ranking component 360 may rank the search results to generate ranked search results 365 (e.g., as discussed above with respect to FIG. 2, FIG. 3, FIG. 7A, FIG. 7B, FIG. 8A, FIG. 8B, etc.). In one embodiment, step 2070 may be performed similarly to and/or analogously to step 270 of process 200.

In one embodiment, the ranking may be performed in step 2070 based on or otherwise using data 2245. For example, search results may be ranked in step 2070 based on a frequency of at least one semantic key (e.g., in at least one document associated with data 2245), based on a frequency of at least one semantic sub-key (e.g., in at least one document associated with data 2245), based on a frequency of at least one keyword of the search query (e.g., in at least one document associated with data 2245), based on a proximity or distance (e.g., measured in words, lines, paragraphs, etc.) between at least one semantic key and at least one keyword of the search query (e.g., in at least one document associated with data 2245), based on a proximity or distance (e.g., measured in words, lines, paragraphs, etc.) between at least one semantic sub-key and at least one keyword of the search query (e.g., in at least one document associated with data 2245), etc.

And in one embodiment, the ranking may be performed in step 2070 using the semantic key (e.g., 2232, determined in step 2010 and/or step 2020, etc.) and/or at least one semantic sub-key associated with the semantic key. For example, search results may be ranked in step 2070 based on a frequency of the semantic key (e.g., in at least one document associated with data 2245), based on a frequency of at least one semantic sub-key (e.g., in at least one document associated with data 2245), based on a proximity or distance (e.g., measured in words, lines, paragraphs, etc.) between the semantic key and at least one keyword of the search query (e.g., in at least one document associated with data 2245), based on a proximity or distance (e.g., measured in words, lines, paragraphs, etc.) between at least one semantic sub-key and at least one keyword of the search query (e.g., in at least one document associated with data 2245), etc.

As shown in FIG. 20, step 2080 involves outputting the search results (e.g., the search results accessed in step 2050, the filtered search results generated in step 2060, the ranked search results generated in step 2070, etc.). For example, graphical data generator 370 may output at least one search result (e.g., 375) for presentation (e.g., as discussed above with respect to FIG. 2, FIG. 3, etc.). In one embodiment, the at least one search result (e.g., 375) may be output in step 2080 for presentation based on input 377. And in one embodiment, step 2080 may be performed similarly to and/or analogously to step 280 of process 200.

In one embodiment, process 2000 may be used to search for and/or output advertising content. For example, where the search results accessed in step 2050 include advertising content (e.g., at least one advertisement), step 2080 may involve outputting the search results (e.g., including advertising content). The search results (e.g., including advertising content) may be output in step 2080 to be presented contemporaneously with webpage search results (e.g., using an on-screen graphical user interface such as user interface 2100, user interface 2700, etc.). In one embodiment, the webpage search results and the search results including advertising content may be generated or accessed based on the same search query, the same at least one semantic key, the same at least one semantic sub-key, some combination thereof, etc. In this manner, embodiments of the present invention enable adverting content to be returned (e.g., responsive to a search performed using a search query, at least one semantic key, at least one semantic sub-key, some combination thereof, etc.) and/or displayed contemporaneously with webpage search results, where the advertising content (e.g., associated with at least one semantic key, at least one semantic sub-key, some combination thereof, etc.) may be more relevant to the search query and/or the webpage search results.

Although FIG. 20 shows process 2000 with a specific number of steps, it should be appreciated that process 2000 may have a different number of steps in other embodiments. Although FIG. 20 shows process 2000 with a specific ordering of steps, it should be appreciated that process 2000 may have a different ordering of steps in other embodiments.

Although FIG. 21 depicts user interface 2100 with a certain number and arrangement of elements, it should be appreciated that user interface 2100 may have a different number and/or arrangement of elements in other embodiments. Additionally, although FIG. 21 depicts elements of user interface 2100 with a certain size and shape, it should be appreciated that elements of user interface 2100 may be a different size and/or shape in other embodiments.

Although FIG. 22 shows data flow diagram 2200 with a specific number of components, it should be appreciated that data flow diagram 2200 may include a different number of components in other embodiments. Although FIG. 22 shows data flow diagram 2200 with a specific arrangement of components, it should be appreciated that data flow diagram 2200 may include a different arrangement of components in other embodiments.

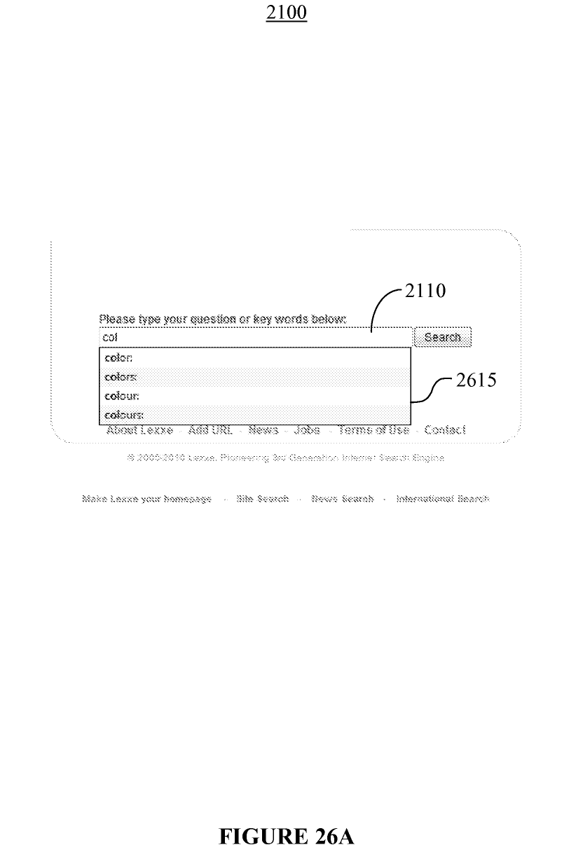

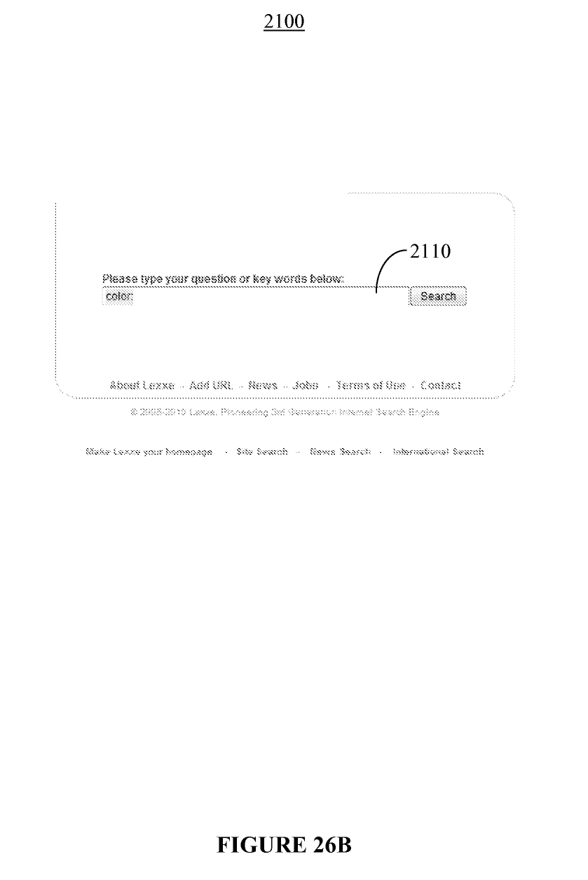

FIGS. 26A and 26B show exemplary on-screen graphical user interface 2100 depicting an automated completion or suggestion of a semantic keyword in accordance with one embodiment of the present invention. As shown in FIG. 26A, responsive to the entry of the letters “col” (e.g., by a user using region 2110 of user interface 2100), region 2615 may be automatically displayed. Region 2615 may include at least one semantic key (e.g., “color,” “colors,” “colour” and “colours”) associated with the entry (e.g., the letters “col”) in region 2110. In one embodiment, region 2615 may be a drop-down list box or other form element enabling a user to select a semantic key.

In one embodiment, responsive to the selection of a semantic key using region 2615, the selected semantic key may be automatically displayed in region 2110. For example, as shown in FIG. 26B, the semantic key “color” may be automatically displayed in region 2110 responsive to a selection of the semantic key “color” from region 2615. Additionally, responsive to a selection of a semantic key using region 2615, region 2615 may be hidden or not displayed (e.g., as shown in FIG. 26B).

Accordingly, embodiments enable more efficient selection and entry of semantic keys and/or search data (e.g., including at least one semantic key and data forming a search query) for use in searching. Additionally, embodiments enable users to determine and/or select semantic keys without prior knowledge of the semantic keys. For example, where a user is not aware that the word “color” is a semantic key, region 2615 may display the semantic key “color” (and/or one or more other semantic keys related thereto) responsive to entry of one or more letters in region 2110 (e.g., the letter “c,” the letters “co,” etc.). As such, region 2615 may be used to inform a user of one or more possible semantic keys for selection.

Although FIGS. 26A and 26B depict user interface 2100 with a certain number and arrangement of elements, it should be appreciated that user interface 2100 may have a different number and/or arrangement of elements in other embodiments. Additionally, although FIGS. 26A and 26B depict elements of user interface 2100 with a certain size and shape, it should be appreciated that elements of user interface 2100 may be a different size and/or shape in other embodiments.

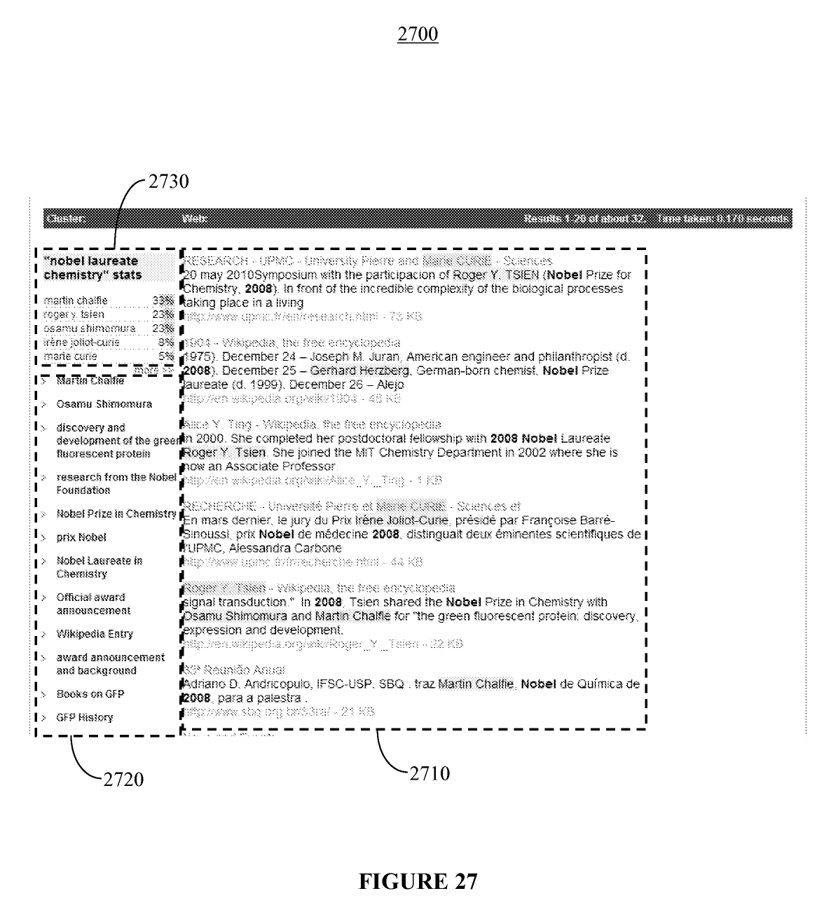

FIG. 27 shows exemplary on-screen graphical user interface 2700 for presenting search results in accordance with one embodiment of the present invention. As shown in FIG. 27, region 2710 includes at least one search result (e.g., 375). Region 2710 may also include respective information (e.g., a document identifier, title, URL, etc.) associated with each search result. And in one embodiment, region 2710 may include at least one search result generated responsive to a search performed based on search data (e.g., 2210, including at least one semantic key and a search query, etc.).

Region 2720 may include at least one semantic sub-key associated with a semantic key (e.g., 2234, determined based on search query focus 335, etc.). In one embodiment, a new search may be performed responsive to an interaction with a semantic sub-key displayed in region 2720. The new search may be performed based on a modified search query, where the modified search query may further include the semantic sub-key (e.g., selected from region 2720). The search results generated as a result of the new search may be displayed in region 2710 in one embodiment. And in one embodiment, the modification of the search query may be transparent to and/or hidden from a user (e.g., not displayed in a graphical user interface such as user interface 2100, another graphical user interface used to perform or initiate a search, etc.).

As shown in FIG. 27, region 2730 may include at least one statistical parameter associated with the at least one search result displayed in region 2710. For example, region 2730 may include a list of items (e.g., at least one word, at least one phrase, at least one semantic key, at least one semantic sub-key, some combination thereof, etc.) found in the at least one search result displayed in region 2710. Region 2730 may also include a respective number or value corresponding to each item in the list. In this manner, region 2730 may be used to provide information about the at least one search result (e.g., displayed in region 2710).

In one embodiment, the number or value may be a number of instances of a corresponding item (e.g., at least one word, at least one phrase, at least one semantic key, at least one semantic sub-key, some combination thereof, etc.) in the search results (e.g., displayed in region 2710). In one embodiment, the number or value may be a ratio or proportion associated with a corresponding item. For example, the number or value may be determined by dividing a number of instances of a corresponding item in the search results by a number of instances of a plurality of items (e.g., including the corresponding item, including all items displayed in region 2730, including all semantic sub-keys associated with at least one semantic key, etc.) in the search results. In one embodiment, the number or value may be associated with a frequency of a corresponding item in the search results. And in one embodiment, the number or value may be associated with other numerical information associated with a corresponding item (e.g., where the numerical information may be determined from one or more of the search results displayed in region 2710). For example, where an item displayed in region 2730 includes the semantic key “Mandarin,” the numerical information may include a number of people who speak Mandarin.

In one embodiment, a new search may be performed responsive to an interaction with a word or phrase displayed in region 2730. The new search may be performed based on a modified search query, where the modified search query may further include the word or phrase (e.g., selected from region 2730). The search results generated as a result of the new search may be displayed in region 2710 in one embodiment. And in one embodiment, the modification of the search query may be transparent to and/or hidden from a user (e.g., not displayed in a graphical user interface such as user interface 2100, another graphical user interface used to perform or initiate a search, etc.).

In one embodiment, portions of the at least one search result (e.g., displayed in region 2710) corresponding to words or phrases found in region 2730 may be highlighted or otherwise indicated to a user (e.g., using a border surrounding the portion, etc.). In this manner, users can easily and efficiently find terms in the at least one search result displayed in region 2710.

In one embodiment, a new search may be performed responsive to an interaction with a portion of at least one search result (e.g., corresponding to a word or phrase displayed in region 2730) displayed in region 2710. The new search may be performed based on a modified search query, where the modified search query may further include the portion of at least one search result (e.g., selected from region 2710). The search results generated as a result of the new search may be displayed in region 2710 in one embodiment. And in one embodiment, the modification of the search query may be transparent to and/or hidden from a user (e.g., not displayed in a graphical user interface such as user interface 2100, another graphical user interface used to perform or initiate a search, etc.).

Although FIG. 27 depicts user interface 2700 with a certain number and arrangement of elements, it should be appreciated that user interface 2700 may have a different number and/or arrangement of elements in other embodiments. Additionally, although FIG. 27 depicts elements of user interface 2700 with a certain size and shape, it should be appreciated that elements of user interface 2700 may be a different size and/or shape in other embodiments.

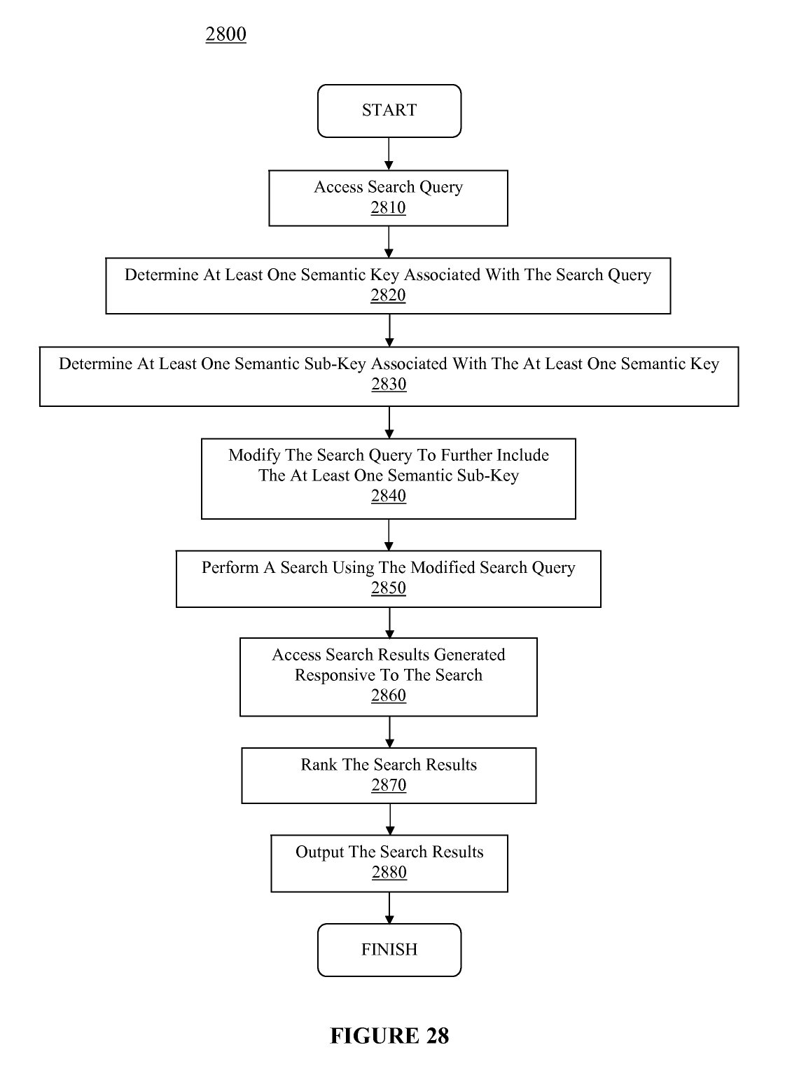

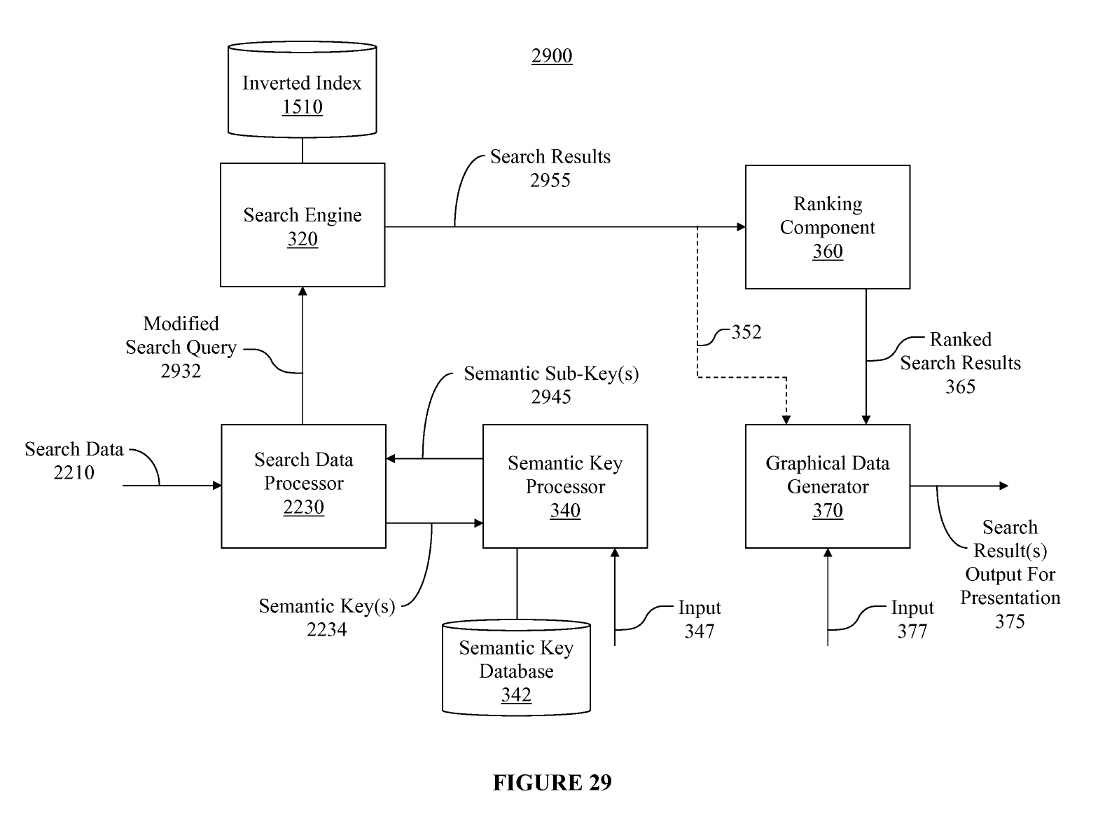

FIG. 28 shows an exemplary flow diagram of computer-implemented process 2800 for performing a search based on an altered search query in accordance with one embodiment of the present invention. As the steps of process 2800 are described herein, reference will be made to exemplary data flow diagram 2900 of FIG. 29 to provide examples and help clarify the discussion.

As shown in FIG. 28, step 2810 involves accessing a search query (e.g., from search data 2210, search query input 310, etc.). In one embodiment, where the search query is accessed from search data (e.g., 2210), the search query may be extracted from the search data or otherwise generated by a search data processor (e.g., 2230).

Step 2820 involves determining at least one semantic key associated with the search query (e.g., accessed in step 2810). In one embodiment, the at least one semantic key may be determined (e.g., using search data processor 2230) from search data (e.g., 2210) in step 2820. In one embodiment, the at least one semantic key may be determined (e.g., using grammatical analyzer 330 and/or semantic key processor 340) in step 2820 based on a focus of a search query (e.g., 335), where the search query focus (e.g., 335) may be used to index a semantic key database (e.g., 342) to access the at least one semantic key.

As shown in FIG. 28, step 2830 involves determining at least one semantic sub-key (e.g., 2945 as shown in FIG. 29) associated with the at least one semantic key (e.g., determined in step 2820). In one embodiment, the at least one semantic sub-key may be determined (e.g., using semantic key processor 340) by indexing a semantic key database (e.g., 342) using the semantic key to access the at least one semantic sub-key (e.g., 2945 as shown in FIG. 29).

Step 2840 involves modifying the search query to further include the at least one semantic sub-key (e.g., 2945). In one embodiment, the search query (e.g., accessed in step 2810) may be modified to further include the at least one semantic sub-key (e.g., 2945) by search data processor 2230, where search data processor 2230 may output the modified search query as modified search query 2932 (e.g., as shown in FIG. 29).

Step 2850 involves performing a search based on the modified search query (e.g., 2932, generated in step 2840, etc.). The search may be a keyword search (e.g., based upon one or more words or keywords of the modified search query). Search engine 320 may perform the search in step 2850 based on the modified search query and generate search results 2955 based thereon (e.g., by indexing inverted index 1510 using modified search query 2932 to access and/or generate search results 2955). The search results (e.g., 2955) may include at least one webpage, at least one electronic document or file, advertising content, some combination thereof, etc. In one embodiment, the search results generated in step 2850 (e.g., search results 2955) may be the same or similar to the filtered search results (e.g., 355) output by filtering component 350 (e.g., as shown in FIG. 22).

As shown in FIG. 20, step 2860 involves accessing search results (e.g., 2955) generated responsive to the search (e.g., performed in step 2850). The search results may be accessed by a component capable of ranking the search results (e.g., ranking component 360 as shown in FIG. 22) in one embodiment.

Step 2870 involves ranking the search results (e.g., 2955, the search results accessed in step 2860, etc.). For example, ranking component 360 may rank the search results (e.g., 2955) to generate ranked search results 365 (e.g., as discussed above with respect to FIG. 2, FIG. 3, FIG. 7A, FIG. 7B, FIG. 8A, FIG. 8B, etc.). In one embodiment, step 2870 may be performed similarly to and/or analogously to step 270 of process 200.

In one embodiment, the ranking may be performed in step 2870 based on or data associated with search data (e.g., 2210) or a portion thereof (e.g., a search query, at least one semantic key 2234, etc.). For example, search results may be ranked in step 2870 based on a frequency of at least one semantic key (e.g., 2234, determined in step 2820, etc.), based on a frequency of at least one semantic sub-key (e.g., associated with at least one semantic key 2234, determined in step 2830, etc.), based on a frequency of at least one keyword of the search query (e.g., accessed in step 2810), based on a proximity or distance (e.g., measured in words, lines, paragraphs, etc.) between at least one semantic key (e.g., 2234, determined in step 2820, etc.) and at least one keyword of the search query (e.g., accessed in step 2810), based on a proximity or distance (e.g., measured in words, lines, paragraphs, etc.) between at least one semantic sub-key (e.g., associated with at least one semantic key 2234, determined in step 2830, etc.) and at least one keyword of the search query (e.g., accessed in step 2810), etc.

As shown in FIG. 28, step 2880 involves outputting the search results (e.g., the search results accessed in step 2860, the ranked search results generated in step 2870, etc.). For example, graphical data generator 370 may output at least one search result (e.g., 375) for presentation (e.g., as discussed above with respect to FIG. 2, FIG. 3, etc.). In one embodiment, the at least one search result (e.g., 375) may be output in step 2880 for presentation based on input 377. And in one embodiment, step 2880 may be performed similarly to and/or analogously to step 280 of process 200.

In one embodiment, process 2800 may be used to search for and/or output advertising content. For example, where the search results accessed in step 2860 include advertising content (e.g., at least one advertisement), step 2880 may involve outputting the search results (e.g., including advertising content). The search results (e.g., including advertising content) may be output in step 2880 to be presented contemporaneously with webpage search results (e.g., using an on-screen graphical user interface such as user interface 2100, user interface 2700, etc.). In one embodiment, the webpage search results and the search results including advertising content may be generated or accessed based on the same search query (e.g., a search query modified to include at least one semantic sub-key associated with at least one semantic key), the same at least one semantic key, the same at least one semantic sub-key, some combination thereof, etc. For example, webpage search results and the search results including advertising content may be generated or accessed based on modified search query 2932 which includes one or more semantic sub-keys 2945 (e.g., “Coke,” “Pepsi,” “Fanta,” “Dr. Pepper,” etc.) associated with one or more semantic keys 2234 (e.g., “soft drink”). In this manner, embodiments of the present invention enable adverting content to be returned (e.g., responsive to a search performed using a search query, at least one semantic key, at least one semantic sub-key, some combination thereof, etc.) and/or displayed contemporaneously with webpage search results, where the advertising content (e.g., associated with at least one semantic key, at least one semantic sub-key, some combination thereof, etc.) may be more relevant to the search query and/or the webpage search results.

Although FIG. 28 shows process 2800 with a specific number of steps, it should be appreciated that process 2800 may have a different number of steps in other embodiments. Although FIG. 28 shows process 2800 with a specific ordering of steps, it should be appreciated that process 2800 may have a different ordering of steps in other embodiments.

Although FIG. 29 shows process 2900 with a specific number of steps, it should be appreciated that process 2900 may have a different number of steps in other embodiments. Although FIG. 29 shows process 2900 with a specific ordering of steps, it should be appreciated that process 2900 may have a different ordering of steps in other embodiments.

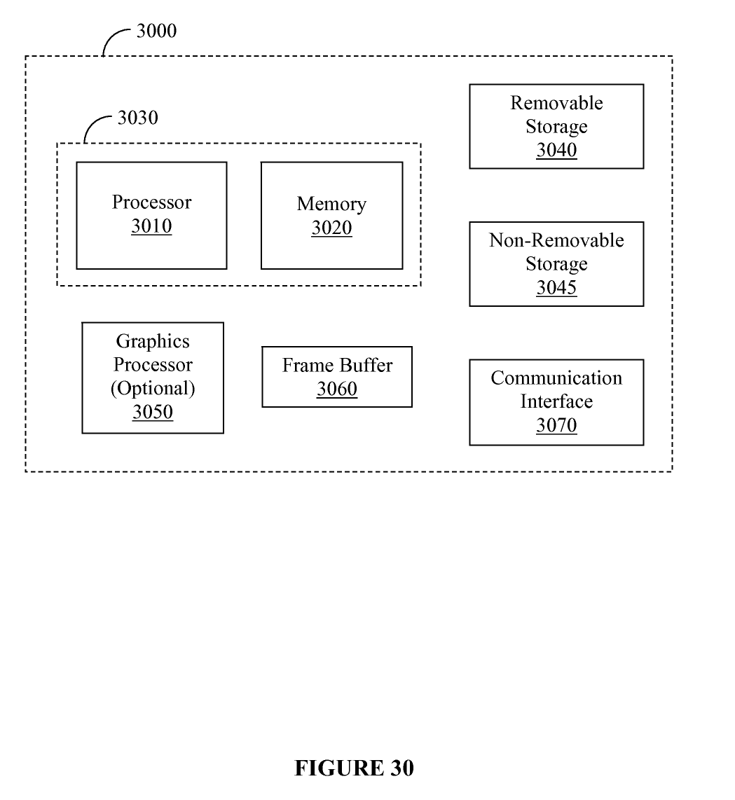

FIG. 30 shows exemplary computer system platform 3000 upon which embodiments of the present invention may be implemented. As shown in FIG. 30, portions of the present invention may be implemented by execution of computer-readable instructions or computer-executable instructions that may reside in components of computer system platform 3000 and which may be used as a part of a general purpose computer network. It is appreciated that computer system platform 3000 of FIG. 30 is merely exemplary. As such, the present invention can operate within a number of different systems including, but not limited to, general-purpose computer systems, embedded computer systems, laptop computer systems, hand-held computer systems, portable computer systems, or stand-alone computer systems.

In one embodiment, computer system platform 3000 may be used to implement web server 110, computer system 120, computer system 130, computer system 440, computer system 550, some combination thereof, etc. And in one embodiment, one or more components of computer system platform 3000 may be disposed in and/or coupled with a housing or enclosure.

In one embodiment, depicted by dashed lines 3030, computer system platform 3000 may include at least one processor 3010 and at least one memory 3020. Processor 3010 may include a central processing unit (CPU) or other type of processor. Depending on the configuration and/or type of computer system environment, memory 3020 may include volatile memory (e.g., RAM), non-volatile memory (e.g., ROM, flash memory, etc.), or some combination of the two. Additionally, memory 3020 may be removable, non-removable, etc.

In other embodiments, computer system platform 3000 may include additional storage (e.g., removable storage 3040, non-removable storage 3045, etc.). Removable storage 3040 and/or non-removable storage 3045 may include volatile memory, non-volatile memory, or any combination thereof. Additionally, removable storage 3040 and/or non-removable storage 3045 may include CD-ROM, digital versatile disks (DVD) or other optical storage, magnetic cassettes, magnetic tape, magnetic disk storage or other magnetic storage devices, or any other medium which can be used to store information for access by computer system platform 3000.

As shown in FIG. 30, computer system platform 3000 may communicate with other systems, components, or devices via communication interface 3070. Communication interface 3070 may embody computer-readable instructions, data structures, program modules or other data in a modulated data signal (e.g., a carrier wave) or other transport mechanism. By way of example, and not limitation, communication interface 3070 may couple to wired media (e.g., a wired network, direct-wired connection, etc.) and/or wireless media (e.g., a wireless network, a wireless connection utilizing acoustic, RF, infrared, or other wireless signaling, etc.).

Communication interface 3070 may also couple computer system platform 3000 to one or more input devices (e.g., a keyboard, a mouse, a trackball, a joystick, a pen, a voice input device, a touch input device, etc.). In one embodiment, communication interface 3070 may couple computer system platform 3000 to one or more output devices (e.g., a display, a speaker, a printer, etc.).

As shown in FIG. 30, graphics processor 3050 may perform graphics processing operations on graphical data stored in frame buffer 3060 or another memory (e.g., 3020, 3040, 3045, etc.) of computer system platform 3000. Graphical data stored in frame buffer 3060 may be accessed, processed, and/or modified by components (e.g., graphics processor 3050, processor 3010, etc.) of computer system platform 3000 and/or components of other systems/devices. Additionally, the graphical data may be accessed (e.g., by graphics processor 3050) and displayed on an output device coupled to computer system platform 3000. Accordingly, memory 3020, removable storage 3040, non-removable storage 3045, frame buffer 3060, or a combination thereof, may be a computer-readable medium or computer-usable medium and may include instructions that when executed by a processor (e.g., 3010, 3050, etc.) implement a method of performing webpage searches (e.g., in accordance with process 200 of FIG. 2), determining a semantic key based upon a focus of a search query (e.g., in accordance with process 400 of FIG. 4), filtering webpage search results (e.g., in accordance with process 700 of FIG. 7A), filtering webpage search results using text generated from keyword search results (e.g., in accordance with process 800 of FIG. 8A), ranking webpage search results in accordance with a semantic sub-key frequency (e.g., in accordance with process 900 of FIG. 9), ranking webpage search results in accordance with a keyword frequency (e.g., in accordance with process 1000 of FIG. 10), ranking webpage search results in accordance with a proximity of semantic sub-keys and search query keywords (e.g., in accordance with process 1100 of FIG. 11), creating a semantic key database (e.g., in accordance with process 1600 of FIG. 16), performing a search (e.g., in accordance with process 2000 of FIG. 20), modifying a search query to further include at least one semantic sub-key (e.g., in accordance with process 2300 of FIG. 23), modifying a search query to further include a semantic key or a portion thereof (e.g., in accordance with process 2500 of FIG. 25), performing a search based on an altered search query (e.g., in accordance with process 2800 of FIG. 28), some combination thereof, etc.

In the foregoing specification, embodiments of the invention have been described with reference to numerous specific details that may vary from implementation to implementation. Thus, the sole and exclusive indicator of what is, and is intended by the applicant to be, the invention is the set of claims that issue from this application, in the specific form in which such claims issue, including any subsequent correction. Hence, no limitation, element, property, feature, advantage, or attribute that is not expressly recited in a claim should limit the scope of such claim in any way. Accordingly, the specification and drawings are to be regarded in an illustrative rather than a restrictive sense.

What is claimed is:

1. A computer-implemented method of performing a search, said method comprising:
accessing search data comprising a semantic key and a search query, wherein said search data is derived from user input via a user interface;
determining at least one document associated with said semantic key; and
performing said search based on said search query to generate search results.

2. The method of claim 1 further comprising:
filtering said search results using said at least one document.

3. The method of claim 1 further comprising:
ranking said search results.

4. The method of claim 1 further comprising:
processing said search data.

5. The method of claim 4, wherein said processing comprises extracting said semantic key and said search query from said search data.

6. The method of claim 4, wherein said processing comprises modifying said search query to further comprise at least one semantic sub-key associated with said semantic key.

7. The method of claim 6 further comprising:
determining at least one attribute associated with said at least one semantic sub-key, and
wherein said processing further comprises modifying said search query to further comprise said at least one semantic sub-key if said search query comprises said at least one attribute.

8. The method of claim 4, wherein said processing comprises modifying the search query to further comprise at least a portion of said semantic key.

9. The method of claim 1, wherein said search results comprise advertising content, and further comprising:
outputting said search results to be presented contemporaneously with webpage search results.

10. The method of claim 9, wherein said webpage search results are generated by a search performed using at least a portion of said search data.

11. The method of claim 1, wherein said semantic key is selected from a group consisting of a word, a number, an email address, an address, a phone number, a fax number, and a concept.

12. A computer-readable medium having computer-readable program code embodied therein for causing a computer system to perform a method of analyzing navigation of a webpage, said method comprising:
accessing search data comprising a semantic key and a search query, wherein said search data is derived from user input via a user interface;
determining at least one document associated with said semantic key; and
performing said search based on said search query to generate search results.

13. The computer-readable medium of claim 12, wherein said method further comprises:
filtering said search results using said at least one document.

14. The computer-readable medium of claim 12, wherein said method further comprises:
ranking said search results.

15. The computer-readable medium of claim 12, wherein said method further comprises:
processing said search data.

16. The computer-readable medium of claim 15, wherein said processing comprises extracting said semantic key and said search query from said search data.

17. The computer-readable medium of claim 15, wherein said processing comprises modifying said search query to further comprise at least one semantic sub-key associated with said semantic key.

18. The computer-readable medium of claim 17, wherein said method further comprises:
determining at least one attribute associated with said at least one semantic sub-key, and
wherein said processing further comprises modifying said search query to further comprise said at least one semantic sub-key if said search query comprises said at least one attribute.

19. The computer-readable medium of claim 15, wherein said processing comprises modifying the search query to further comprise at least a portion of said semantic key.

20. The computer-readable medium of claim 12, wherein said search results comprise advertising content, and further comprising:
outputting said search results to be presented contemporaneously with webpage search results.

21. The computer-readable medium of claim 20, wherein said webpage search results are generated by a search performed using at least a portion of said search data.

22. The computer-readable medium of claim 12, wherein said semantic key is selected from a group consisting of a word, a number, an email address, an address, a phone number, a fax number, and a concept.

23. A system comprising a processor and a memory, wherein said memory comprises instructions that when executed by said system implement a method of analyzing navigation of a webpage, said method comprising:
accessing search data comprising a semantic key and a search query, wherein said search data is derived from user input via a user interface;
determining at least one document associated with said semantic key; and
performing said search based on said search query to generate search results.

24. The system of claim 23, wherein said method further comprises:
filtering said search results using said at least one document.

25. The system of claim 23, wherein said method further comprises:
ranking said search results.

26. The system of claim 23, wherein said method further comprises:
processing said search data.

27. The system of claim 26, wherein said processing comprises extracting said semantic key and said search query from said search data.

28. The system of claim 26, wherein said processing comprises modifying said search query to further comprise at least one semantic sub-key associated with said semantic key.

29. The system of claim 28, wherein said method further comprises:
determining at least one attribute associated with said at least one semantic sub-key, and
wherein said processing further comprises modifying said search query to further comprise said at least one semantic sub-key if said search query comprises said at least one attribute.

30. The system of claim 26, wherein said processing comprises modifying the search query to further comprise at least a portion of said semantic key.

31. The system of claim 23, wherein said search results comprise advertising content, and further comprising:
outputting said search results to be presented contemporaneously with webpage search results.

32. The system of claim 31, wherein said webpage search results are generated by a search performed using at least a portion of said search data.

33. The system of claim 23, wherein said semantic key is selected from a group consisting of a word, a number, an email address, an address, a phone number, a fax number, and a concept.
